(19) United States
(12) Patent Application Publication
(10) Pub. No.: US 2023/0078832 A1
(43) Pub. Date: Mar. 16, 2023

(54) SYSTEM AND METHOD FOR COMMUNICATION BETWEEN SIMULATORS

(71) Applicant: BETA AIR, LLC, South Burlington, VT (US)

(72) Inventor: Herman Wiegman, Essex Junction, VT (US)

(73) Assignee: BETA AIR, LLC, South Burlington, VT (US)

(21) Appl. No.: 17/476,939

(22) Filed: Sep. 16, 2021

(51) Int. Cl. G06F 30/20

(52) U.S. Cl. CPC G06F 30/20; G06F 2111/02

(57) ABSTRACT

A system for instantaneous communication between simulators is presented. The system includes a plurality of simulation devices, wherein each simulation device includes a computing device, wherein the computing device is configured to receive an input datum, simulate a vehicle performance model output, generate a simulation datum as a function of the performance model output, and transmit the simulation datum to a communication device. The system further includes a mesh network configured to communicatively connect the plurality of simulation devices. The system further includes a communication device, wherein the communication device includes, an authentication module, and a plurality of communication components, wherein each communication component configured to facilitate real-time communication between the plurality of simulation devices. The system further includes at least a database, wherein the at least a database configured to store the simulation datum.

### FIELD OF THE INVENTION

The present invention generally relates to the field of simulation. In particular, the present invention is directed to a system and method for communication between simulators.

### BACKGROUND

Simulators serve to provide realistic simulations of the operation of many vehicles. Operating a vehicle poses a great amount of risk in which people may be concerned about operating vehicle or being around an operating vehicle. Simulators further serve to create an imitation of a real-life operation of a vehicle. Simulators can also serve to train users or pilots to substitute the complexity and difficulty found in current systems and methods of training. Existing simulators are limited in imitating an isolated representation of operating a vehicle.

### SUMMARY OF THE DISCLOSURE

In an aspect, a system for instantaneous communication between simulators is presented. The system includes a plurality of simulation devices, wherein each simulation device includes a computing device, wherein the computing device is configured to receive an input datum, simulate a vehicle performance model output, generate a simulation datum as a function of the performance model output, and transmit the simulation datum to a communication device. The system further includes a mesh network configured to communicatively connect the plurality of simulation devices. The system further includes a communication device, wherein the communication device includes, an authentication module, and a plurality of communication components, wherein each communication component configured to facilitate real-time communication between the plurality of simulation devices. The system further includes at least a database, wherein the at least a database configured to store the simulation datum.

In another aspect, a method for instantaneous communication between simulation device is presented. The method includes receiving, by a computing device of a simulation device of a plurality of simulation devices, an input datum, simulating a vehicle performance model output, generating a simulation datum as a function of the performance model output, transmitting the simulation datum to a communication device, communicatively connecting the plurality of simulation devices as a function of a mesh network, authenticating each simulation device as a function of an authentication module, facilitating, by each communication component of a plurality of communication components of the communication device, real-time communication between the plurality of simulation devices, and storing the simulation datum in at least a database.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of a system for instantaneous communication between simulators;

FIG. 2 is a block diagram of another exemplary embodiment of a system for instantaneous communication between simulators;

FIG. 3 is a block diagram of an exemplary embodiment of an authentication module

FIG. 4 is a block diagram illustrating an exemplary embodiment of an authentication database;

FIG. 5 is a block diagram illustrating an exemplary embodiment of a biometric database;

FIG. 6 is a block diagram illustrating an embodiment of a pilot training module;

FIG. 7 is a block diagram illustrating an embodiment of a training database;

FIG. 8 is a block diagram of an exemplary embodiment of a system for a mesh network for a vehicle;

FIG. 9 is a flow diagram of an exemplary method for instantaneous communication between simulators;

FIG. 10 is an illustration of an exemplary embodiment of an electric aircraft;

FIG. 11 is a block diagram of an exemplary flight controller;

FIG. 12 is a block diagram of an exemplary machine-learning process; and

FIG. 13 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for communication between simulators. In an embodiment, aspects of the present disclosure can be used to operate one or more vehicles in one or more simulators. Multiple simulators can be used to simulate operating vehicles such as an electric aircraft or electric vertical take-off and landing (eVTOL) aircraft. Aspects of the present disclosure can be used to simulate an imitation of an aircraft highway system with multiple users interacting with each other in simulation. In an embodiment, users may use simulators, which may be located in remote or isolated positions form each other.

Aspects of the present disclosure can be used to train pilots or users on how to operate a vehicle in an imitation of a real-life situation with a trainer. In an embodiment, the trainer may be allowed to take control of the trainee's simulator. A trainer may override any input of a trainee in a trainee's simulator. A trainer may control an eVTOL of a trainee's simulation. This is so, at least in part, to provide improved training methods between a trainer and trainee. The trainer's simulator may be able to display the simulation environment of the trainee's simulator to have a better understanding of the trainee's perspective in order to enhance the training experience of both trainer and trainee.

Aspects of the present disclosure can be used to maintain and use a digital simulation of a vehicle in conjunction with a simulator and/or a simulator module. Aspects of the present disclosure can also be used to communicate vehicle and/or simulation data between at least the digital simulation and at least a vehicle component and vice versa. Aspects of the present disclosure allow for simulated operation of an electric aircraft, as well as simulated maintenance and testing of the electric aircraft. This is so, at least in part, to ensure accuracy of vehicle simulation for training, testing, and maintenance purpose. Exemplary embodiments illustrating aspects of the present disclosure are described below in the context of several specific examples.

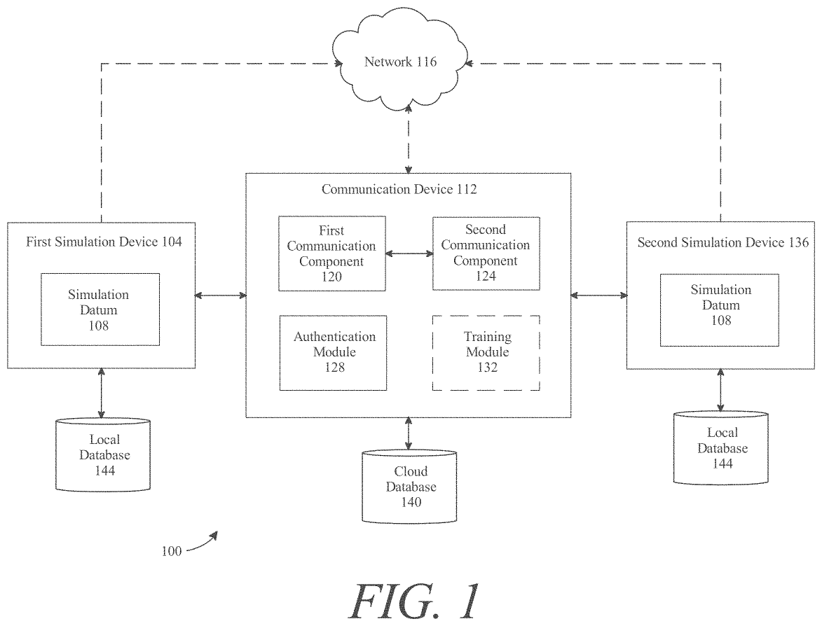

Referring now to FIG. 1, a block diagram of an exemplary embodiment of a system 100 for instantaneous communication between simulators is provided. System 100 includes a plurality of simulation devices. A plurality of simulation devices may include first simulation device 104. System 100 may include second simulation device 136. A “simulation device,” for the purpose of this disclosure, is a program or set of operations that simulates operation of a vehicle. A “first simulation device”, as used in this disclosure, is an initial program or set of operations that simulates an operation of a vehicle. A “second simulation device”, as used in this disclosure, is any additional program or set of operations that simulates an operation of a vehicle. In a non-limiting embodiment, first simulation device 104 may be the same as second simulation device 136. In a non-limiting embodiment, first simulation device 104 may not be the same as second simulation device 136. In a non-limiting embodiment, system 100 may include a plurality of simulation devices. In a non-limiting embodiment, any simulation device may include any device that is configured to artificially re-create vehicle flight and the environment in which the vehicle exists. In a non-limiting embodiment, first simulation device 104 and/or second simulation device 136 may be configured to simulate a vehicle operation of a ground vehicle such as cars, trucks, boats, motorcycles, tanks, or any ground vehicle and the like thereof. In a non-limiting embodiment, first simulation device 104 and/or second simulation device 136 may be configured to simulate a vehicle operation of any airborne vehicle such as aircrafts, electric aircraft, eVTOL, unmanned aerial vehicles, drones, and the like thereof. In a non-limiting embodiment, first simulation device 104 and/or second simulation device 136 may include a flight simulator. For instance and without limitation, the flight simulator may be consistent with the flight simulator in U.S. patent application Ser. No. 17/348,916 and titled “METHODS AND SYSTEMS FOR SIMULATED OPERATION OF AN ELECTRIC VERTICAL TAKE-OFF AND LANDING (EVTOL) AIRCRAFT,” which is incorporated herein by reference in its entirety. In some cases, first simulation device 104 and/or second simulation device 136 may simulate vehicle operation within an environment, for example, an environmental atmosphere in which a vehicle such as an aircraft may fly, airports at which aircraft take-off and land, and/or mountains and other hazards aircraft attempt to avoid crashing into. In some cases, an environment may include geographical, atmospheric, and/or biological features. In some cases, first simulation device 104 and/or second simulation device 136 may model an artificial and/or virtual aircraft in flight as well as an environment in which the artificial and/or virtual aircraft flies. In some cases, first simulation device 104 and/or second simulation device 136 may include one or more physics models, which represent analytically or through data-based, such as without limitation machine-learning processes, physical phenomenon. Physical phenomenon may be associated with an aircraft and/or an environment. For example, some versions of first simulation device 104 and/or second simulation device 136 may include thermal models representing aircraft components by way of thermal modeling. Thermal modeling techniques may, in some cases, include analytical representation of one or more of convective hear transfer (for example by way of Newton's Law of Cooling), conductive heat transfer (for example by way of Fourier conduction), radiative heat transfer, and/or advective heat transfer. In some cases, first simulation device 104 and/or second simulation device 136 may include models representing fluid dynamics. For example, in some embodiments, flight simulator may include a representation of turbulence, wind shear, air density, cloud, precipitation, and the like. In some embodiments, first simulation device 104 and/or second simulation device 136 may include at least a model representing optical phenomenon. For example, first simulation device 104 and/or second simulation device 136 may include optical models representative of transmission, reflectance, occlusion, absorption, attenuation, and scatter. In a non-limiting embodiment, first simulation device 104 and/or second simulation device 136 may include non-analytical modeling methods; for example, the flight simulator may include, without limitation, a Monte Carlo model for simulating optical scatter within a turbid medium, for example clouds. In some embodiments, first simulation device 104 and/or second simulation device 136 may represent Newtonian physics, for example motion, pressures, forces, moments, and the like. An exemplary flight simulator may include Microsoft Flight Simulator from Microsoft of Redmond, Wash., U.S.A.

With continued reference to FIG. 1, each simulation device may be operated independently by a user. In a non-limiting embodiment, first simulation device 104 may be configured to simulate an operation of a vehicle while second simulation device 136 may be configured to simulate an operation of another vehicle. For example and without limitation, both simulations generated from first simulation device 104 and second simulation device 136 may interact with each other in the simulation. For example and without limitation, first simulation device 104 and second simulation device 136 may be configured to simulate vehicle operations in the same simulated reality world as a function of a network. A “simulated reality world,” for the purpose of this disclosure, is a simulation of an environment in which users may interact with each other via simulators such as, but not limited to, first simulation device 104 and/or simulation device 136. Persons skilled in the art, upon reviewing the entirety of this disclosure, will be aware of the various embodiments of simulated reality in which users may interact in simulation for purposes as described herein.

With continued reference to FIG. 1, a plurality of simulation devices may be configured to communicate with each other as a function of network 116. In a non-limiting embodiment, each simulation device may be located isolated from each other and connected via network 116. A “network”, for the purpose of this disclosure, is any medium configured to facilitate communication between two or more devices. Network 116 may include any network described in this disclosure, for example without limitation an avionic mesh network as described below. In a non-limiting embodiment, first simulation device 104 may transmit a sensor to second simulation device 136 through network 116. In a non-limiting embodiment, network 116 may be communicatively connected to each simulation device of the plurality of simulation devices. In some cases, network 116 may include a mesh network. A mesh network may include, without limitation, an avionic mesh network. For instance and without limitation, the avionic mesh network may be consistent with the avionic mesh network in U.S. patent application Ser. No. 17/348,916 and titled “METHODS AND SYSTEMS FOR SIMULATED OPERATION OF AN ELECTRIC VERTICAL TAKE-OFF AND LANDING (EVTOL) AIRCRAFT,” which is incorporated herein by reference in its entirety. In some embodiments, network 116 may include an intra-aircraft network and/or an inter-aircraft network. Intra-aircraft network may include any intra-aircraft network described in this disclosure. Inter-aircraft network may include any inter-aircraft network described in this disclosure.

With continued reference to FIG. 1, first simulation device 104 and/or second simulation device 136 may include a computing device. In a non-limiting embodiment, first simulation device 104 and/or second simulation device 136 may include a flight controller or an imitation of a flight controller that may also be part of the simulation device. In a non-limiting embodiment, any simulation device may include a computing device which may also include a flight controller. The computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. computing device may include a single computing device operating independently, or may include two or more computing device operating in concert, in parallel, sequentially or the like; two or more computing devices may be included together in a single computing device or in two or more computing devices. computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. computing device may include but is not limited to, for example, a computing device or cluster of computing devices in a first location and a second computing device or cluster of computing devices in a second location. computing device may include one or more computing devices dedicated to data storage, security, distribution of traffic for load balancing, and the like. computing device may distribute one or more computing tasks as described below across a plurality of computing devices of computing device, which may operate in parallel, in series, redundantly, or in any other manner used for distribution of tasks or memory between computing devices. computing device may be implemented using a “shared nothing” architecture in which data is cached at the worker, in an embodiment, this may enable scalability of system 100 and/or computing device.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, the computing device and/or flight controller may be controlled by one or more Proportional-Integral-Derivative (PID) algorithms driven, for instance and without limitation by stick, rudder and/or thrust control lever with analog to digital conversion for fly by wire as described herein and related applications incorporated herein by reference. A “PID controller”, for the purposes of this disclosure, is a control loop mechanism employing feedback that calculates an error value as the difference between a desired setpoint and a measured process variable and applies a correction based on proportional, integral, and derivative terms; integral and derivative terms may be generated, respectively, using analog integrators and differentiators constructed with operational amplifiers and/or digital integrators and differentiators, as a non-limiting example. A similar philosophy to attachment of flight control systems to sticks or other manual controls via pushrods and wire may be employed except the conventional surface servos, steppers, or other electromechanical actuator components may be connected to the cockpit inceptors via electrical wires. Fly-by-wire systems may be beneficial when considering the physical size of the aircraft, utility of for fly by wire for quad lift control and may be used for remote and autonomous use, consistent with the entirety of this disclosure. The computing device may harmonize vehicle flight dynamics with best handling qualities utilizing the minimum amount of complexity whether it be additional modes, augmentation, or external sensors as described herein.

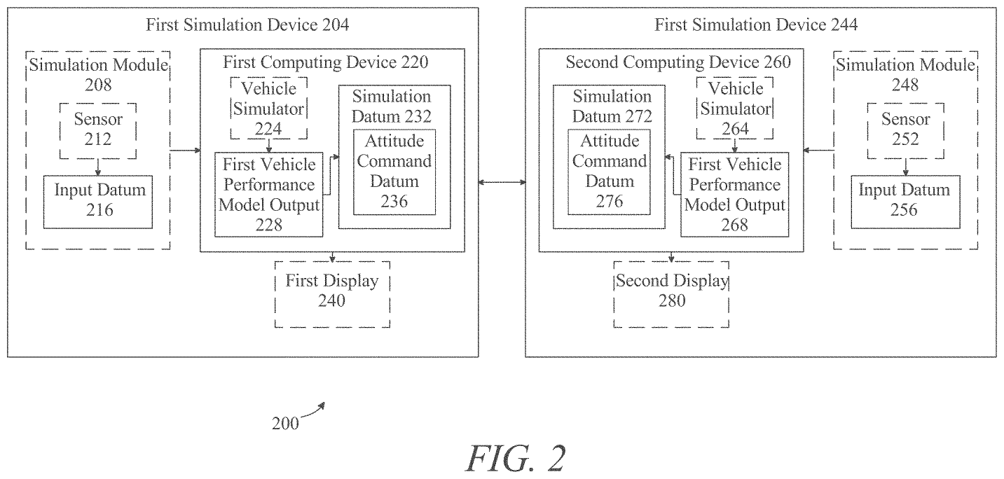

With continued reference to FIG. 1, first simulation device 104 and/or second simulation device 136 may be configured to generate simulation datum 108. In a non-limiting embodiment, any simulation device may be configured to generate simulation datum 108. A “simulation datum”, for the purpose of this disclosure, is an element of data describing any simulated outside parameter of a simulation of a vehicle in a simulated reality. Any datum or signal herein may include an electrical signal. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. In a non-limiting embodiment, simulation datum 108 may include a simulated input datum. A “simulated input datum,” for the purpose of this disclosure, is any input by a user of a simulator mimicking a user input of a real vehicle. In some embodiments, simulated input datum may include input datum 216 as described in further detail below with reference to FIG. 2.

Still referring to FIG. 1, for example and without limitation, the simulated input datum may include a pilot input of a simulator comprising an inceptor stick that may be translated into simulation datum 108 in the simulated reality. In a non-limiting embodiment, simulation datum 108 may include any datum describing the performance of a simulated vehicle in any operation. For example and without limitation, simulation datum 108 may include a plurality of simulated data of the simulated vehicle's velocity, torque, altitude, angle of attack, power consumption, and the like thereof. In a non-limiting embodiment, each simulation device of a plurality of simulation devices of a simulated reality or network may be configured to generate respective simulation datum 108 to its own simulated vehicle. In a non-limiting embodiment, each simulation device may be configured to view, in real-time, the movements of other simulated vehicles in the perspective of the users of other simulation devices. For example and without limitation, second simulation device 136 may view the point of view of the user of first simulation device 104 and its simulation datum 108. In some embodiments, simulation datum 108 may include first vehicle performance model output 228 and/or second vehicle performance model output 268 as described in detail below with reference to FIG. 2. Persons skilled in the art, upon reviewing the entirety of this disclosure, will be aware of the various embodiments of simulated data of a simulated vehicle that mimics real data of a real vehicle for purposes as described herein.

With continued reference to FIG. 1, system 100 may include communication device 112, wherein communication device 112 may be configured to facilitate any communication between each simulation device of the plurality of simulation devices such as, but not limited to, first simulation device 104 and/or second simulation device 136. A “communication device,” for the purpose of this disclosure, is any device or module configured to control a network and communicate any simulation device with each other. In some embodiments, communication device 112 may include a plurality of communication components. “Communication components” as used in this disclosure are any devices capable of receiving and transmitting data. Communication device 112 may use a plurality of communication components to generate various networking systems and/or layers. In a non-limiting embodiment, communication device 112 may be configured to create network 116. For example and without limitation, communication device 112 may create a layered data network that uses radio communication, mobile network communication, and/or satellite communication. In a non-limiting embodiment, communication device 112 may include an automated broadcaster or a simulated automated broadcaster, wherein the automated broadcaster is configured to receive any datum such as simulation datum 108 from any simulation device such as first simulation device 104 and/or second simulation device 136 and transmit the any datum to other simulation devices when connected to network 116. An “automated broadcaster,” for the purposes of this disclosure, is a device configured to transmit and receive signals from the plurality of simulation devices. The automated broadcaster may include an Automatic Dependent Surveillance-Broadcast (ADS-B) which includes a surveillance technology in which a simulated vehicle may determine the position of the simulated vehicle of its respected simulation device. In a non-limiting embodiment, the automated broadcaster may include a physical CAN bus unit, or combination thereof, and periodically broadcasts the position of the simulated vehicle, enabling the simulated vehicle to be tracked. In a non-limiting embodiment, communication device 112 may be configured to act as a communication hub for a simulated air traffic control as a part of a simulated reality or environment where the plurality of simulation devices may operate a simulated vehicle. In a non-limiting embodiment, the automated broadcaster of communication device 112 may be used as a medium for users of the simulation devices to communicate with each in simulation of a real-life operation of a vehicle such as an aircraft flying in the air to imitate the real-life communication of flying aircrafts. For example and without limitation, the data from automated broadcaster can also be received by other aircrafts to provide situational awareness and allow self-separation. In a non-limiting embodiment, ADS-B is “automatic” in that it requires no pilot or external input. It is “dependent” in that it depends on data from the aircraft's navigation system. In a non-limiting embodiment, the automated broadcaster may be configured to be a hub for digital communication with at least a simulated air traffic control operator of the simulated air traffic control. For example and without limitation, the simulated air traffic control may be operated by another user of another simulation device. Persons skilled in the art, upon reviewing the entirety of this disclosure, will be aware of the various simulated parties involved in imitating real-life communication of vehicles and their operations for purposes as described herein.

With continued reference to FIG. 1, communication device 112 may be configured to support digital communication. A “digital communication,” for the purposes of this disclosure, refer to a mode of transfer and reception of data over a communication channel via digital signals. Digital signals may include, but not limited to, audio signals, electrical signals, video signals, radar signals, radio signals, sonar signals, transmission signals, LIDAR signals and the like thereof. Digital communication may include, but not limited to, data transmission, data reception, a communication system, and the like. A communication system that may support digital communication may include a plurality of individual telecommunications networks, transmission systems, relay stations, tributary stations, and the like. In a non-limiting embodiment, communication device 112 may be configured to transfer data such as simulation datum 108 over a point-to-point or point-to-multipoint communication channels which may include, but not limited to, copper wires, optical fibers, wireless communication channels, storage media, computer buses and the like. The data being transmitted may be represented as, but not limited to, electromagnetic signals, electrical voltage, radio wave, microwave, infrared signals, and the like. In a non-limiting embodiment, transmission of data via digital communication may be conducted using any network methodology. A person of ordinary skill in the art, after viewing the entirety of this disclosure, would appreciate the transmission of data in the context of network methodologies and digital communication.

With continued reference to FIG. 1, communication device 112 and/or the plurality of simulation devices may include a plurality of physical controller area network buses. A “physical controller area network bus,” as used in this disclosure, is vehicle bus unit including a central processing unit (CPU), a CAN controller, and a transceiver designed to allow devices to communicate with each other's applications without the need of a host computer which is located physically at the aircraft. For instance and without limitation, CAN bus unit may be consistent with disclosure of CAN bus unit in U.S. patent application Ser. No. 17/218,342 and titled “METHOD AND SYSTEM FOR VIRTUALIZING A PLURALITY OF CONTROLLER AREA NETWORK BUS UNITS COMMUNICATIVELY CONNECTED TO AN AIRCRAFT,” which is incorporated herein by reference in its entirety. Physical controller area network (CAN) bus unit may include physical circuit elements that may use, for instance and without limitation, twisted pair, digital circuit elements/FGPA, microcontroller, or the like to perform, without limitation, processing and/or signal transmission processes and/or tasks; circuit elements may be used to implement CAN bus components and/or constituent parts as described in further detail below. Physical CAN bus unit may include multiplex electrical wiring for transmission of multiplexed signaling. Physical CAN bus unit may include message-based protocol(s), wherein the invoking program sends a message to a process and relies on that process and its supporting infrastructure to then select and run appropriate programing. A plurality of physical CAN bus units located physically at the aircraft may include mechanical connection to the aircraft, wherein the hardware of the physical CAN bus unit is integrated within the infrastructure of the aircraft.

With continued reference to FIG. 1, communication device 112 may include first communication component 120. Communication device 112 may include second communication component 124. A “first communication component,” for the purpose of this disclosure, is a transceiver configured to transfer simulation datum 108 of first simulation device 104. A “second communication component,” for the purpose of this disclosure, is a transceiver configured to transfer simulation datum 108 of second simulation device 136. In a non-limiting embodiment, first communication component 120 may be the same as second communication component 124. In a non-limiting embodiment, communication device 112 may include a plurality of communication component wherein each communication component is associated to a unique simulation device of the plurality of simulation devices. In a non-limiting embodiment, a communication component may include a transceiver, or any device configured to support the receiving and transmitting of signals. In a non-limiting embodiment, first communication component 120 may transmit simulation datum 108 from first simulation device 104 to second communication component 124 wherein second communication component 124 may transmit simulation datum 108 of first simulation device 104 to second simulation device 136, and vice versa. In a non-limiting embodiment, first simulation device 104 may transmit simulation datum 108 to second simulation device 136 which may be a request to view real-time movement of the simulated vehicle of second simulation device 136 or take control of the simulation vehicle. In a non-limiting embodiment, communication device 112 may be configured to incorporate authentication module 128. An “authentication module,” for the purpose of this disclosure, is any suitable software and/or hardware configured to authenticate a user of a simulation device and/or simulated vehicle operated by the user and its simulation device. Authentication module 128 may be configured to receive a credential associated with a user from a simulation device, compare the credential from the simulation device to an authorized credential stored within an authentication database, and bypass authentication for the simulation device based on the comparison of the credential from the simulation device to the authorized credential stored within an authentication database. In some embodiments, comparing a credential may include verifying the credential with an authorized credential stored within an authentication database. In some embodiments, comparing a credential may include matching the credential with an authorized credential stored within an authentication database. In some embodiments, bypassing authentication may include validating authentication of a simulation device. In some embodiments, bypassing authentication may include proceeding through an authentication check to gain access to communication device 112. A “credential” as described in the entirety of this disclosure, is any datum representing an identity, attribute, code, and/or characteristic specific to a user and/or simulation device. In a non-limiting embodiment, authentication module 128 may be configured to authenticate a user of a simulation device and/or the simulated vehicle the user is operating. For example and without limitation, first simulation device 104 may be configured to verify second simulation device 136 before receiving and sending any signals as a function of authentication module 128. For example and without limitation, first simulation device 104 may use authentication module 128 to verify second simulation device 136 before allowing the user of second simulation device 136 to view the real-time movements of first simulation device 104 and/or relinquish control of first simulation device's 104 simulated vehicle, and vice versa. Persons skilled in the art, upon reviewing the entirety of this disclosure, will be aware of the various security measures used for purposes described herein.

With continued reference to FIG. 1, the credential may include a username and password unique to the user and/or simulation device. The username and password may include any alpha-numeric character, letter case, and/or special character. As a further example and without limitation, the credential may include a digital certificate, such as a PKI certificate. The simulation device may include an additional computing device, such as a mobile device, laptop, desktop computer, or the like; as a non-limiting example, the simulation device may be a computer and/or smart phone operated by a pilot-in-training at an airport hangar. The simulation device may include, without limitation, a display in communication with communication device 112; the display may include any display as described in the entirety of this disclosure such as a light emitting diode (LED) screen, liquid crystal display (LCD), organic LED, cathode ray tube (CRT), touch screen, or any combination thereof. Output data from communication device 112 may be configured to be displayed on the simulation device using an output graphical user interface. An output graphical user interface may display any output as described in the entirety of this disclosure. Further, authentication module 128 may be configured to receive a credential from an instructor device which may be a simulation device operated by a trainer and/or instructor. The instructor device may include any additional computing device as described above, wherein the additional computing device is utilized by and/or associated with a certified flight instructor. As a further embodiment, authentication module 128 and/or communication device 112 may be configured to receive a credential from an admin device which may also be another simulation device, or an outside device configured to oversee the simulation and/or simulated reality/environment. The admin device may include any additional computing device as described above in further detail, wherein the additional computing device is utilized by/associated with an employee of an administrative body, such as an employee of the federal aviation administration.

With continued reference to FIG. 1, communication device 112 may be configured to incorporate training module 132. A “training module,” for the purpose of this disclosure, is any suitable software and/or hardware as configured to receive a lesson selection from a user device and/or a simulation device and transmit a plurality of lesson modules to the user device and/or the simulation device as a function of the lesson selection. Pilot training module 132 and/or communication device 112 may be further configured to receive at least an interaction datum from user device 112, receive at least a simulator training datum from a simulator device, and record a module progression datum for each lesson module of the plurality of lesson modules as a function of the interaction datum and the at least a simulator training datum. The at least an interaction datum may include any interaction as described throughout the entirety of this disclosure. User the at least an interaction datum may include, for example and without limitation, an interaction with a reading, activity, assessment, and the like. In a non-limiting embodiment, the at least an interaction datum may include a set of answers for an assessment, a typographical entry correlating to an answer to a question, a video response, any combination thereof, and/or the like. The latest received the at least an interaction datum is configured to correlate to the position of the user within the plurality of lesson module The “plurality of lesson modules”, as described in the entirety of this disclosure, is a collection of data correlated to each course of the plurality of courses required to become a certified electric aircraft pilot. Each course of the plurality of courses may include, for example and without limitation, foundational knowledge, such as definitions, classifications, history and industry information, aircraft and pilot knowledge, such as aircraft instruments, aircraft systems, aeromedical factors and aeronautical decision making, flying environment knowledge, such as airspace, airports, aviation weather, and navigation, regulatory knowledge, such as aircraft classifications, federal aviation administration, flight schools, pilot certifications, in-flight knowledge, such as hovering maneuvers, vertical takeoff and landing, turning, instrument indicators, and emergency operations, and the like. Persons skilled in the art, upon reviewing the entirety of this disclosure, will be aware of various flight simulators that may be employed as simulator machine as described herein.

With continued reference to FIG. 1, the simulation device of the plurality of simulation devices may be configured to store simulation datum 108 in local database 144. In a non-limiting embodiment, a simulation device may consistently store datum into local database 144 throughout the duration of a simulation. In a non-limiting embodiment, the simulation device may be configured to store datum into local database 144 in the event it loses connection with another simulated vehicle and/or another user operating another simulation device. In a non-limiting embodiment, the simulation device may be configured to store simulation datum 108 into local database 144 in the event it loses connection via network 116 and/or communication device 112. In a non-limiting embodiment, locally stored datum in local database 144 may be retrieved locally. In a non-limiting embodiment, each simulation device may include a corresponding local database used to store simulation datum 108 generated by its respective simulation device. Communication device 112 may be configured to store any data received and/or analyzed into cloud database 140. In a non-limiting embodiment, cloud database 140 may be accessed by any simulation device as long as it is connected to network 116 and/or communication device 112. In a non-limiting embodiment, cloud database may be accessed by an outside user device such as the admin device. Persons skilled in the art, upon reviewing the entirety of this disclosure, will be aware the various embodiments and purposes for using locally stored and cloud stored databases as described herein.

Now referring to FIG. 2, a block diagram of another exemplary embodiment of a system 200 for instantaneous communication between simulators is provided. System 200 may include first simulation device 204. First simulation device 204 may include any first simulation device as described herein. System 200 may include second simulation device 244. Second simulation device 244 may include any second simulation device as described herein. First simulation device 204 may include simulation module 208. A “simulator module” is a physical component that is a simulation of a vehicle or vehicle component. For instance and without limitation, simulation module 208 may be consistent with simulation module in U.S. patent application Ser. No. 17/348,916 and titled “METHODS AND SYSTEMS FOR SIMULATED OPERATION OF AN ELECTRIC VERTICAL TAKE-OFF AND LANDING (EVTOL) AIRCRAFT,” which is incorporated herein by reference in its entirety. The simulation of a vehicle may include a simulation of an aircraft such as an electric aircraft. Simulator module may include actual aircraft components that have been separated from a functioning aircraft or otherwise de-activated. Simulator module 208 may include a model or replica. In some cases, simulator module may include a physical twin of at least an aircraft component. In some cases, simulator module may include a physical cockpit. The physical cockpit may include at least an aircraft component. For example, a physical cockpit may include one or more of an aircraft interior, seating, windows, displays, pilot controls, and the like. A physical cockpit may be used to perform a simulated flight mission. As used in this disclosure, a “simulated flight mission” is any use of a flight simulator that includes a simulated flight. Simulator module 208 and/or physical cockpit may include at least a pilot control configured to interface with a user. The pilot control may include any pilot control described in this disclosure. In some cases, at least one of simulator module 208, physical cockpit, and pilot control may include at least sensor 212. Sensor 212 may be communicatively connected to first computing device 220. First computing device 220 may include any computing device as described herein.

With continued reference to FIG. 2, a “sensor,” for the purposes of this disclosure, is an electronic device configured to detect, capture, measure, or combination thereof, a plurality of external and electric vehicle component quantities. Sensor 212 may be integrated and/or connected to at least an actuator, a portion thereof, or any subcomponent thereof. Sensor 212 may include a photodiode configured to convert light, heat, electromagnetic elements, and the like thereof, into electrical current for further analysis and/or manipulation. Sensor 212 may include circuitry or electronic components configured to digitize, transform, or otherwise manipulate electrical signals. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. The plurality of datum captured by sensor 212 may include circuitry, computing devices, electronic components or a combination thereof that translates into at least an electronic signal configured to be transmitted to another electronic component. Sensor 212 may be disposed on at least an actuator of the electric aircraft. An “actuator,” for the purpose of this disclosure, is any flight component or any part of an electric aircraft that helps it to achieve physical movements by converting energy, often electrical, air, or hydraulic, into mechanical force and enable movement. “Disposed,” for the purpose of this disclosure, is the physical placement of a computing device on an actuator. In a non-limiting embodiment, actuator may include a flight component. In a non-limiting embodiment, sensor 212 may include a plurality of individual sensors disposed on each actuator of the electric aircraft. In a non-limiting embodiment, sensor 212 may be mechanically and communicatively connected to one or more throttles. The throttle may be any throttle as described herein, and in non-limiting examples, may include pedals, sticks, levers, buttons, dials, touch screens, one or more computing devices, and the like. Additionally, a right-hand floor-mounted lift lever may be used to control the amount of thrust provided by the lift fans or other propulsors. The rotation of a thumb wheel pusher throttle may be mounted on the end of this lever and may control the amount of torque provided by the pusher motor, or one or more other propulsors, alone or in combination. Any throttle as described herein may be consistent with any throttle described in U.S. patent application Ser. No. 16/929,206 and titled, “Hover and Thrust Control Assembly for Dual-Mode Aircraft”, which is incorporated herein in its entirety by reference. Sensor 212 may be mechanically and communicatively connected to an inceptor stick. The pilot input may include a left-hand strain-gauge style STICK for the control of roll, pitch and yaw in both forward and assisted lift flight. A 4-way hat switch on top of the left-hand stick enables the pilot to set roll and pitch trim. Inceptor stick may include any inceptor stick as described in the entirety of this disclosure. Persons skilled in the art, upon reviewing the entirety of this disclosure, will be aware various embodiments and functions of a pilot input and inceptor stick for purposes as described herein.

Still referring to FIG. 2, simulation module 208 may include an aircraft control. As used in this disclosure an “aircraft control” is a control and/or guidance system that maneuvers the aircraft. In an embodiment, the aircraft control may include a mechanical and/or manually operated flight control system. For example, and without limitation the aircraft control may include a collective control. As used in this disclosure a “collective control” is a mechanical control of an aircraft that allows a pilot and/or other operator to adjust and/or control the pitch angle of aircraft. For example and without limitation, collective control may alter and/or adjust a pitch angle of all the main rotor blades collectively. For example, and without limitation the aircraft control may include a yoke control. As used in this disclosure a “yoke control” is a mechanical control of an aircraft to control the pitch and/or roll. For example and without limitation, yoke control may alter and/or adjust the roll angle of aircraft as a function of controlling and/or maneuvering ailerons. In an embodiment, the aircraft control may include one or more foot brakes, control sticks, pedals, throttle levels, and the like thereof. Additionally or alternatively, the aircraft control may be configured to translate a desired command from plurality of measured flight data. As used in this disclosure a “desired command” is a direction and/or command that a pilot desires, wishes, and/or wants for a flight component. In an embodiment, and without limitation, desired command may include a desired torque for a flight component. For example, and without limitation, the aircraft control may translate that a desired torque for a propeller be 160 lb. ft. of torque. As a further non-limiting example, the aircraft control may translate that a pilot's desired torque for a propulsor be 290 lb. ft. of torque. In another embodiment, the aircraft control may include a digital and/or automated flight control system. For example, and without limitation, the aircraft control may include a computing device and/or flight controller capable of producing an autonomous function. Persons skilled in the art, upon reviewing the entirety of this disclosure, will be aware of the various embodiments of an aircraft control for the purposes as described in the entirety of this disclosure.

Referring still to FIG. 2, sensor 212 may be mechanically and communicatively connected to a foot pedal. In a non-limiting embodiment, simulation module 208 may incorporate wheeled landing gear steerable by differential braking accessed by floor mounted pedals; in the event of installing such a foot actuated “caveman” infrastructure, yaw control also may be affected through differential foot pressure. A stick may be calibrated at zero input (relaxed state) and at the stops in pitch and roll. The calibration may be done in both directions of roll and both directions of pitch. Any asymmetries may be handled by a bilinear calibration with the breakpoint at the neutral point. Likewise, a yaw zero point may correspond to a relaxed state of an inceptor stick. The full-scale torque in each twist direction may be independently calibrated to the maximum torque seen in the calibration process in that direction. In all phases of flight, the control surface deflections may be linearly mapped to their corresponding maximum stick deflections and neutral position. In the case of roll, where there may be more aileron deflection in the trailing edge up direction, the degrees of deflection per pilot input unit may be different in each direction, such that full surface deflection may be not reached until full stick deflection. When the lift fans are engaged, the pilot's stick inputs may correspond to roll and pitch altitude (+/−30 deg) and yaw rate (+/−60 deg/second) commands, which are also linearly mapped to the full range of stick travel. A breakout force of 2-3 Newtons (0.5 lbf minimums mil spec 1797 min breakout force) measured at center of stick grip position may be applied prior to the linear mapping. Breakout force prevents adverse roll yaw coupling. In order to remove the need for constant control input in steady forward flight, pitch and roll trim may be available. Pitch trim may be limited to +7 deg pitch up trim and −5 deg pitch down trim, which may be sufficient to trim for level flight over the entire center of gravity and cruise airspeed range in non-limiting examples. Roll trim limited to 2 degrees (average between the ailerons) may be also available. The trim may be applied after the breakout force to change the input that center stick corresponds to. This trimmed command applies to both the altitude commands when the lift rotors are powered, and the control surface deflections at all times. In order to ensure the pilot can always access the full capability of the aircraft, the mapping below from pre-trim input to post-trim input may be used when trim is nonzero. Note that with positive trim, the effective sensitivity in the positive direction has decreased while the sensitivity in the negative direction has increased. This is a necessary byproduct of enforcing the constraint that full stick deflection yields full control surface deflection. The lift lever has very low additional breakout torque and requires a constant (but adjustable) torque of 3.1 Nm during movement, which translates to 2 lbf at the intended grip position. Control of the lift motors may be only active when the assisted lift lever may be raised above 3.75 degrees from the full down stop (out of 25 degrees total). This may represent a debounce mechanism that may be determined based on the friction of the assisted lift lever, the mass and the expected cockpit vibration levels. A mechanical detent may be installed on the lift lever at an angle corresponding to 15% average torque in order to provide kinesthetic feedback to the pilot of the minimum lift lever setting which provides adequate control authority via the lift fans.

With continued reference to FIG. 2, sensor 212 may include a motion sensor. A “motion sensor”, for the purposes of this disclosure is a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. Sensor 212 may include, but not limited to, torque sensor, gyroscope, accelerometer, magnetometer, inertial measurement unit (IMU), pressure sensor, force sensor, proximity sensor, displacement sensor, vibration sensor, LIDAR sensor, and the like. In a non-limiting embodiment sensor 212 ranges may include a technique for the measuring of distances or slant range from an observer including sensor 212 to a target which may include a plurality of outside parameters. “Outside parameter,” for the purposes of this disclosure, refer to environmental factors or physical electric vehicle factors including health status that may be further be captured by sensor 212. Outside parameter may include, but not limited to air density, air speed, true airspeed, relative airspeed, temperature, humidity level, and weather conditions, among others. Outside parameter may include velocity and/or speed in a plurality of ranges and direction such as vertical speed, horizontal speed, changes in angle or rates of change in angles like pitch rate, roll rate, yaw rate, or a combination thereof, among others. Outside parameter may further include physical factors of the components of the electric aircraft itself including, but not limited to, remaining fuel or battery. Outside parameter may include at least an environmental parameter. Environmental parameter may be any environmentally based performance parameter as disclosed herein. Environment parameter may include, without limitation, time, pressure, temperature, air density, altitude, gravity, humidity level, airspeed, angle of attack, and debris, among others. Environmental parameters may be stored in any suitable datastore consistent with this disclosure. Environmental parameters may include latitude and longitude, as well as any other environmental condition that may affect the landing of an electric aircraft. Technique may include the use of active range finding methods which may include, but not limited to, light detection and ranging (LIDAR), radar, sonar, ultrasonic range finding, and the like. In a non-limiting embodiment, sensor 212 may include at least a LIDAR system to measure ranges including variable distances from sensor 212 to a potential landing zone or flight path. LIDAR systems may include, but not limited to, a laser, at least a phased array, at least a microelectromechanical machine, at least a scanner and/or optic, a photodetector, a specialized GPS receiver, and the like. In a non-limiting embodiment, sensor 212 including a LIDAR system may targe an object with a laser and measure the time for at least a reflected light to return to the LIDAR system. LIDAR may also be used to make digital 4-D representations of areas on the earth's surface and ocean bottom, due to differences in laser return times, and by varying laser wavelengths. In a non-limiting embodiment the LIDAR system may include a topographic LIDAR and a bathymetric LIDAR, wherein the topographic LIDAR that may use near-infrared laser to map a plot of a land or surface representing a potential landing zone or potential flight path while the bathymetric LIDAR may use water-penetrating green light to measure seafloor and various water level elevations within and/or surrounding the potential landing zone. In a non-limiting embodiment, electric aircraft may use at least a LIDAR system as a means of obstacle detection and avoidance to navigate safely through environments to reach a potential landing zone. Sensor 212 may include sensor 212 suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor.

With continued reference to FIG. 2, simulator module 208 may include at least sensor 212 which may further include sensor 212 suite. One or more sensors may be communicatively connected to at least a pilot control, the manipulation of which, may constitute at least an aircraft command. “Communicative connecting”, for the purposes of this disclosure, refers to two or more components electrically, or otherwise connected and configured to transmit and receive signals from one another. Signals may include electrical, electromagnetic, visual, audio, radio waves, or another undisclosed signal type alone or in combination. Any datum or signal herein may include an electrical signal. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. At least sensor 212 may include circuitry, computing devices, electronic components or a combination thereof that translates input datum 216 into at least an electronic signal configured to be transmitted to another electronic component. At least sensor 212 communicatively connected to at least a pilot control may include sensor 212 disposed on, near, around or within at least pilot control.

Further referring to FIG. 2, at least pilot control may be physically located in the cockpit of the aircraft or remotely located outside of the aircraft in another location communicatively connected to at least a portion of the aircraft. “Communicatively connection”, for the purposes of this disclosure, is a process whereby one device, component, or circuit is able to receive data from and/or transmit data to another device, component, or circuit; communicative connecting may be performed by wired or wireless electronic communication, either directly or by way of one or more intervening devices or components. In an embodiment, communicative connecting includes electrically coupling an output of one device, component, or circuit to an input of another device, component, or circuit. Communicative connecting may be performed via a bus or other facility for intercommunication between elements of a computing device. Communicative connecting may include indirect connections via “wireless” connection, low power wide area network, radio communication, optical communication, magnetic, capacitive, or optical coupling, or the like. At least pilot control may include buttons, switches, or other binary inputs in addition to, or alternatively than digital controls about which a plurality of inputs may be received. At least pilot control may be configured to receive pilot input. Pilot input may include a physical manipulation of a control like a pilot using a hand and arm to push or pull a lever, or a pilot using a finger to manipulate a switch. Pilot input may include a voice command by a pilot to a microphone and computing system consistent with the entirety of this disclosure. One of ordinary skill in the art, after reviewing the entirety of this disclosure, would appreciate that this is a non-exhaustive list of components and interactions thereof that may include, represent, or constitute, or be connected to sensor 212.

In an embodiment, and still referring to FIG. 2, sensor 212 may be attached to one or more pilot inputs and attached to one or more pilot inputs, one or more portions of an aircraft, and/or one or more structural components, which may include any portion of an aircraft as described in this disclosure. As used herein, a person of ordinary skill in the art would understand “attached” to mean that at least a portion of a device, component, or circuit is connected to at least a portion of the aircraft via a mechanical connection. Said mechanical connection can include, for example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, hirth joints, hydrodynamic coupling, jaw coupling, magnetic coupling, Oldham coupling, sleeve coupling, tapered shaft lock, twin spring coupling, rag joint coupling, universal joints, or any combination thereof. In an embodiment, mechanical coupling can be used to connect the ends of adjacent parts and/or objects of an electric aircraft. Further, in an embodiment, mechanical coupling can be used to join two pieces of rotating electric aircraft components. Control surfaces may each include any portion of an aircraft that can be moved or adjusted to affect altitude, airspeed velocity, groundspeed velocity or direction during flight. For example, control surfaces may include a component used to affect the aircrafts' roll and pitch which may comprise one or more ailerons, defined herein as hinged surfaces which form part of the trailing edge of each wing in a fixed wing aircraft, and which may be moved via mechanical means such as without limitation servomotors, mechanical linkages, or the like, to name a few. As a further example, control surfaces may include a rudder, which may include, without limitation, a segmented rudder. The rudder may function, without limitation, to control yaw of an aircraft. Also, control surfaces may include other flight control surfaces such as propulsors, rotating flight controls, or any other structural features which can adjust the movement of the aircraft. A “control surface” as described herein, is any form of a mechanical linkage with a surface area that interacts with forces to move an aircraft. A control surface may include, as a non-limiting example, ailerons, flaps, leading edge flaps, rudders, elevators, spoilers, slats, blades, stabilizers, stabilators, airfoils, a combination thereof, or any other mechanical surface are used to control an aircraft in a fluid medium. Persons skilled in the art, upon reviewing the entirety of this disclosure, will be aware of various mechanical linkages that may be used as a control surface, as used and described in this disclosure.

Still referring to FIG. 2, sensor 212 may include a plurality of sensors in the form of individual sensors or sensor 212 suite working in tandem or individually. Sensor 212 suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings. At least sensor 212 may be configured to detect pilot input from at least pilot control. At least pilot control may include a throttle lever, inceptor stick, collective pitch control, steering wheel, brake pedals, pedal controls, toggles, joystick. One of ordinary skill in the art, upon reading the entirety of this disclosure would appreciate the variety of pilot input controls that may be present in an electric aircraft consistent with the present disclosure. Inceptor stick may be consistent with disclosure of inceptor stick in U.S. patent application Ser. No. 17/001,845 and titled “A HOVER AND THRUST CONTROL ASSEMBLY FOR DUAL-MODE AIRCRAFT”, which is incorporated herein by reference in its entirety. Collective pitch control may be consistent with disclosure of collective pitch control in U.S. patent application Ser. No. 16/929,206 and titled “HOVER AND THRUST CONTROL ASSEMBLY FOR DUAL-MODE AIRCRAFT”, which is incorporated herein by reference in its entirety.

With continued reference to FIG. 2, sensor 212 may be configured to detect input datum 216. An “input datum,” for the purpose of this disclosure, is any datum or element of data identifying and/or a pilot input or command. Input datum 216 may include a manipulation of one or more pilot input controls as described above that correspond to a desire to affect a simulated vehicle's trajectory such as an aircraft's trajectory as a function of the movement of one or more flight components and one or more propulsors, alone or in combination. “Flight components”, for the purposes of this disclosure, includes components related to, and mechanically connected to an aircraft that manipulates a fluid medium in order to propel and maneuver the aircraft through the fluid medium. The operation of the aircraft through the fluid medium will be discussed at greater length hereinbelow. In a non-limiting embodiment, input datum 216 may include information gathered by one or more sensors. At least a pilot control may be communicatively connected to any other component presented in system, the communicative connection may include redundant connections configured to safeguard against single-point failure. Pilot input may indicate a pilot's desire to change the heading or trim of an electric aircraft. Pilot input may indicate a pilot's desire to change an aircraft's pitch, roll, yaw, or throttle. Aircraft trajectory is manipulated by one or more control surfaces and propulsors working alone or in tandem consistent with the entirety of this disclosure, hereinbelow. Pitch, roll, and yaw may be used to describe an aircraft's altitude and/or heading, as they correspond to three separate and distinct axes about which the aircraft may rotate with an applied moment, torque, and/or other force applied to at least a portion of an aircraft. “Pitch”, for the purposes of this disclosure refers to an aircraft's angle of attack, that is the difference between the aircraft's nose and the horizontal flight trajectory. For example, an aircraft pitches “up” when its nose is angled upward compared to horizontal flight, like in a climb maneuver. In another example, the aircraft pitches “down”, when its nose is angled downward compared to horizontal flight, like in a dive maneuver. When angle of attack is not an acceptable input to any system disclosed herein, proxies may be used such as pilot controls, remote controls, or sensor levels, such as true airspeed sensors, pitot tubes, pneumatic/hydraulic sensors, and the like. “Roll” for the purposes of this disclosure, refers to an aircraft's position about its longitudinal axis, that is to say that when an aircraft rotates about its axis from its tail to its nose, and one side rolls upward, like in a banking maneuver. “Yaw”, for the purposes of this disclosure, refers to an aircraft's turn angle, when an aircraft rotates about an imaginary vertical axis intersecting the center of the earth and the fuselage of the aircraft. “Throttle”, for the purposes of this disclosure, refers to an aircraft outputting an amount of thrust from a propulsor. Pilot input, when referring to throttle, may refer to a pilot's desire to increase or decrease thrust produced by at least a propulsor. In a non-limiting embodiment, input datum 216 may include an electrical signal. In a non-limiting embodiment, input datum 216 may include mechanical movement of any throttle consistent with the entirety of this disclosure. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. At least sensor 212 may include circuitry, computing devices, electronic components or a combination thereof that translates pilot input into input datum 216 configured to be transmitted to any other electronic component.

With continued reference to FIG. 2, the plurality of measured aircraft datum may include a flight datum. A “flight datum,” for the purpose of this disclosure, is any datum or element of data describing physical parameters of individual actuators and/or flight components of an electric aircraft or logistical parameters of the electric aircraft. In a non-limiting embodiment, flight datum may include a plurality of data describing the health status of an actuator of a plurality of actuators. In a non-limiting embodiment, the plurality of data may include a plurality of failure data for a plurality of actuators. In a non-limiting embodiment, safety datum may include a measured torque parameter that may include the remaining vehicle torque of a flight component among a plurality of flight components. A “measured torque parameter,” for the purposes of this disclosure, refer to a collection of physical values representing a rotational equivalence of linear force. A person of ordinary skill in the art, after viewing the entirety of this disclosure, would appreciate the various physical factors in measuring torque of an object. For instance and without limitation, remaining vehicle torque may be consistent with disclosure of remaining vehicle torque in U.S. patent application Ser. No. 17/197,427 and titled “SYSTEM AND METHOD FOR FLIGHT CONTROL IN ELECTRIC AIRCRAFT”, which is incorporated herein by reference in its entirety. Remaining vehicle torque may include torque available at each of a plurality of flight components at any point during an aircraft's entire flight envelope, such as before, during, or after a maneuver. For example, and without limitation, torque output may indicate torque a flight component must output to accomplish a maneuver; remaining vehicle torque may then be calculated based on one or more of flight component limits, vehicle torque limits, environmental limits, or a combination thereof. Vehicle torque limit may include one or more elements of data representing maxima, minima, or other limits on vehicle torques, forces, altitudes, rates of change, or a combination thereof. Vehicle torque limit may include individual limits on one or more flight components, structural stress or strain, energy consumption limits, or a combination thereof. Remaining vehicle torque may be represented, as a non-limiting example, as a total torque available at an aircraft level, such as the remaining torque available in any plane of motion or altitude component such as pitch torque, roll torque, yaw torque, and/or lift torque. In a non-limiting embodiment, first computing device 220 may mix, refine, adjust, redirect, combine, separate, or perform other types of signal operations to translate pilot desired trajectory into aircraft maneuvers. In a nonlimiting embodiment a pilot may send a pilot input at a press of a button to capture current states of the outside environment and subsystems of the electric aircraft to be displayed onto an output device in pilot view. The captured current state may further display a new focal point based on that captured current state. In a non-limiting embodiment, first computing device 220 may condition signals such that they can be sent and received by various components throughout the electric vehicle. In a non-limiting embodiment, flight datum may include at least an aircraft angle. At least an aircraft angle may include any information about the orientation of the aircraft in three-dimensional space such as pitch angle, roll angle, yaw angle, or some combination thereof. In non-limiting examples, at least an aircraft angle may use one or more notations or angular measurement systems like polar coordinates, cartesian coordinates, cylindrical coordinates, spherical coordinates, homogenous coordinates, relativistic coordinates, or a combination thereof, among others. In a non-limiting embodiment, flight datum may include at least an aircraft angle rate. At least an aircraft angle rate may include any information about the rate of change of any angle associated with an electrical aircraft as described herein. Any measurement system may be used in the description of at least an aircraft angle rate. Persons skilled in the art, upon reviewing the entirety of this disclosure, will be aware of the various geometric parameters for purposes as described in the entirety of this disclosure.

With continued reference to FIG. 2, first simulation device 204 may include first computing device 220, wherein first computing device 220 may be configured to generate first vehicle performance model output 228 as a function of input datum 216 using vehicle simulator 224. Vehicle simulator 224 may include any vehicle simulator as described herein. A “first vehicle performance model output,” for the purpose of this disclosure, is any simulation and/or model of a vehicle such as, but not limited to, an electric aircraft that embodies an analytical and/or interactive visualization regarding aircraft operation and/or performance capabilities of a first vehicle associated with first simulation device 204. In a non-limiting embodiment, plurality of first vehicle performance model output 228 may include a plurality of simulations of the electric aircraft using the plurality of flight data with each model providing, for each flight component in the set of flight components corresponding, force and moment data for each of a first set of operating conditions based on a first set of simulations performed by varying one or more flight component parameters while holding other flight components at a baseline value and a second set of simulations to determine interactions between the flight component and said other actuators under each of a second set of operating conditions. For example and without limitation, a first set may include a simulation representing one flight component and/or one set of flight components performing as a function of varied flight component parameters while the remaining flight components are configured to be at a cruise control in order to realize the strength, performance, and/or physical qualities of that first set. In a non-limiting embodiment, a second set may repeat a similar procedure as the first set but with a different flight component or a different set of flight components.

With continued reference to FIG. 2, first computing device 220 may be configured to generate first vehicle performance model output 228 as a function of the failure response. A “failure response,” for the purpose of this disclosure, is a controller allocation datum that includes a plurality of instructions and/or commands to resolve a failure event. A “failure event,” for the purpose of this disclosure, is the event of a failure, abnormality, malfunction, or combination thereof, of an electrical component such as, but not limited to, any flight component of the electric aircraft. In a non-limiting embodiment, the failure event may include a malfunction of a rotor, forward pusher, propeller, battery, and the like thereof. For example and without limitation, the failure event may include an instance of a flight component being damaged or detached from the overall body of the electric aircraft during flight. In a non-limiting embodiment, the failure response may include a set of instructions of controller allocation datum configured to compensate for instance of the failure event. For example and without limitation, the failure response may include instructions for remaining flight components to adjust its performance output to maintain stable and steady flight of the electric aircraft to compensate for a malfunctioning flight component. In a non-limiting embodiment, the failure response may include an output of alerts and/or sirens indicating an emergency situation. In a non-limiting embodiment, the failure response may include an automatic transmission of emergency to be received by other entities including an air traffic control. Persons skilled in the art, upon reviewing the entirety of this disclosure, will be aware of the various responses as a trigger of a failure event as disclosed in the entirety of this disclosure. In a non-limiting embodiment, first vehicle performance model output 228 may include a model depicting the performance of the aircraft in which one or more of the flight components are malfunctioning or failing. In a non-limiting embodiment, first vehicle performance model output 228 may be generated during a flight or after a flight has occurred. For example and without limitation, first vehicle performance model output 228 may depict the performance of the aircraft and the aircraft flight components in real time as it is flying in the air. In a non-limiting embodiment, first vehicle performance model output 228 may include a depiction of the flight of the aircraft. In a non-limiting embodiment, first vehicle performance model output 228 may include a plurality of performance parameters include, but not limited to, aircraft velocity, altitude, actuator torque output, and the like thereof. In a non-limiting embodiment, first vehicle performance model output 228 may highlight an abnormality of an actuator and a plurality of performance parameters associated with that abnormal actuator. Persons skilled in the art, upon reviewing the entirety of this disclosure, will be aware of the various embodiments of a simulation and/or model in the context of visualization and analysis consistent with this disclosure.

With continued reference to FIG. 2, plurality of first vehicle performance model output 228 may include at least a battery performance model. A “battery performance model,” for the purpose of this disclosure, is any model or simulation depicting quantifiable metrics of a battery source of an electric aircraft of any first vehicle performance model output 228. The battery model may include any model related to at least property, characteristic, or function of a battery located within aircraft. In some cases, the battery model may include a model of a battery controller, management, and/or monitoring system. Disclosure related to battery management for eVTOL aircraft may be found in patent application Ser. No. 17/108,798 and Ser. No. 17,111,002, entitled “PACK LEVEL BATTERY MANAGEMENT SYSTEM” and “ELECTRICAL DISTRIBUTION MONITORING SYSTEM FOR AN ELECTRIC AIRCRAFT,” respectively, each of which is incorporated herein by reference in its entirety. In some cases, a battery model may include an electrochemical model of battery, which may be predictive of energy efficiencies and heat generation and transfer of at least a battery. In some cases, a battery model may be configured to predict battery lifetime, given known battery parameters, for example measured battery performance, temperature, utilization, and the like. In a non-limiting embodiment, the battery performance model may include a thermal performance. A “thermal performance,” for the purpose of this disclosure, is any temperature related output or data regarding a battery. In a non-limiting embodiment, the battery performance model may include a battery performance metric which may include, but is not limited to, battery charge, battery health, battery temperature, and/or battery usage. In some embodiments, the battery performance model to suggest a better flight maneuver and/or path to preserve the battery of the electric aircraft of a first vehicle performance model output 228. For example and without limitation, the battery performance metric of an first vehicle performance model output 228 may include the battery health, battery consumption rate, battery temperature, and the like thereof, for a set of first vehicle performance model output 228 in which a set may include different battery performance metrics for different first vehicle performance model output 228s modeling varying positions and/or usages of the plurality of flight components of an electric aircraft.

With continued reference to FIG. 2, first computing device 220 may be configured to simulate at least a virtual representation as a function of first vehicle performance model output 228. As described in this disclosure, a “virtual representation” includes any model or simulation accessible by a computing device which is representative of a physical phenomenon, for example without limitation at least an electric aircraft or simulator module. In some cases, virtual representation may be interactive with vehicle simulator 224. For example, in some cases, data may originate from virtual representation and be input into vehicle simulator 224. Alternatively or additionally, in some cases, the virtual representation may modify or transform data already available to vehicle simulator 224. The virtual representation may include first vehicle performance model output 228 of vehicle simulator 224. First vehicle performance model output 228 may include any digital twin as described in this disclosure, for example below. In some cases, vehicle simulator 224 includes an electric vertical take-off and landing (eVTOL) aircraft, for example a functional flight-worthy eVTOL aircraft; and first vehicle performance model output 228 is a digital twin of the eVTOL aircraft. In some cases, the at least a virtual representation may include a virtual controller area network. Virtual controller area network may include any virtual controller area network as described in this disclosure, for example below. In some cases, aircraft digital twin may include a flight controller model. Flight controller model may include any flight controller model described in this disclosure.

With continued reference to FIG. 2, first computing device 220 may be configured to generate simulation datum 232. In a non-limiting embodiment, simulation datum 232 may be generated as a function of first vehicle performance model output 228 and input datum 216. Simulation datum 232 may be any simulation datum as described herein. In a non-limiting embodiment, generating simulation datum may include generating altitude command datum 236. An “altitude command datum,” for the purpose of this disclosure, is any datum describing instructions to configure a simulated vehicle's components to satisfy a requirement. In a non-limiting embodiment, first computing device 204 may generate altitude command datum 236 which may be a set of instructions to control a simulated vehicle to another simulation device such as second simulation device 244. For example and without limitation, the user of first simulation device 204 may be an instructor or trainer feeding instructions to a trainee operating second simulation device 244. In a non-limiting embodiment, first computing device 220 may generate, using a machine-learning algorithm, a machine-learning model, wherein the machine-learning model may be configured to receive input datum 216 and/or first vehicle performance model output 228 as inputs and output altitude command datum 236 using a training set that may be retrieved from local database 144 and/or cloud database 140. The training set may include any past simulation datum and/or any input datum from a previous use of simulation. Persons skilled in the art, upon reviewing the entirety of this disclosure, will be aware of the various simulation datum in the context of feeding instructions for purposes described herein.

With continued reference to FIG. 2, first simulation device 204 may include first display 240 communicatively connected to first computing device 220. In some cases, first display 240 may be configured to display at least a virtual representation. In some cases, first display 240 may be configured to display at least a graphical element of vehicle simulator 224 and/or simulation module 208. In some embodiments, first display 240 may include a plurality of displays and may be configured to display imagery that is immersive to a user. For example, in some cases, first display 240 may include a curved screen or set of screens that cover a field of vision. In some embodiments, first display 240 may be configured to display a field of vision extending peripherally to cover some or all of the field of vision possible from a cockpit of an aircraft. In some cases, first display 240 may include an Omnimax or Imax screen. In some cases, first display 240 may include a projector, for example red, green, blue, (RGB) projectors and the like. In some cases, first display 240 may include multiple screens, which may be joined together to form a larger screen with various possible geometric configurations. In some cases, first display 240 may include multiple projectors. In some cases, first display 240 may include circuitry, hardware, firmware, and/or software to coordinate image display using multiple screens/projectors. For example, circuitry, hardware, firmware, and/or software may be configured to overlap display zones or views from multiple displays, screens, projectors, and the like.

With continued reference to FIG. 2, in some cases, first display 240 may include a stereoscopic display. A “stereoscopic display” as used in this disclosure, is a first display 240 that simulates a user experience of viewing a three-dimensional space and/or object, for instance by simulating and/or replicating different perspectives of a user's two eyes; this is in contrast to a two-dimensional image, in which images presented to each eye are substantially identical, such as may occur when viewing a flat screen display. Stereoscopic first display 240 may display two flat images having different perspectives, each to only one eye (i.e., parallax), which may simulate the appearance of an object or space as seen from the perspective of that eye. Alternatively or additionally, stereoscopic first display 240 may include a three-dimensional first display 240 such as a holographic first display 240 or the like. In some embodiments, first display 240 may include an autostereoscopic display. In some cases, an autostereoscopic display may include a single screen that projects two or more views, which are relayed to different eyes of a viewer, for example without limitation by way of lenticular lenses. In some cases, an autostereoscopic display may include adaptive optics elements, such as adaptive lenticular lenses using indium tin oxide electrodes and a liquid crystal cell, to adjust optical properties of the lenticular lens according to a sensed position of a user's eyes. In some cases, an eye-tracking system, for example a system including an eye-tracking camera, may be used to determine a location of a user's eyes (e.g., pupils) relative a first display 240 and adjust adaptive optics and display parameters accordingly. In some cases, an autostereoscopic display may project multiple views for multiple pairs of eyes, such that different views are viewable from different locations relative first display 240. In some exemplary cases, an autostereoscopic display having a static lenticular lens screen may project 7 different views. Persons skilled in the art, upon reviewing the entirety of this disclosure, will be aware of various alternative or additional types of stereoscopic display that may be employed in augmented reality device. In some cases, first display 240 may include a display usable with a headset, for example an augmented reality or virtual reality headset. For example, in some cases, first display 240 may include a liquid crystal display and/or a heads-up display. Headset may include a screen that displays a field of vision to user. In a non-limiting embodiment, first simulation device 204 may include a projection device, defined as a device that inserts images into field of vision. Projection device may include a software and/or hardware component that adds inserted images into a first display 240 signal to be rendered on the first display 240. Projection device and/or display may make use of reflective waveguides, diffractive waveguides, or the like to transmit, project, and/or display images. For instance, and without limitation, projection device and/or first display 240 may project images through and/or reflect images off an eyeglass-like structure and/or lens piece, where either both field of vision and images from projection device may be so displayed, or the former may be permitted to pass through a transparent surface. Projection device and/or first display 240 may be incorporated in a contact lens or eye tap device, which may introduce images into light entering an eye to cause display of such images. Projection device and/or first display 240 may display some images using a virtual retina display (VRD), which may display an image directly on a retina of user.

With continued reference to FIG. 2. System 200 may include second simulation device 244. Second simulation device 244 may include any second simulation device as described herein. First simulation device 204 may include simulation module 248. Simulation module 248 may include any simulation module as described herein. The simulation of a vehicle may include a simulation of an aircraft such as an electric aircraft. Simulator module may include actual aircraft components that have been separated from a functioning aircraft or otherwise de-activated. Simulator module 248 may include a model or replica. In some cases, simulator module may include a physical twin of at least an aircraft component. In some cases, simulator module may include a physical cockpit. The physical cockpit may include at least an aircraft component. For example, a physical cockpit may include one or more of an aircraft interior, seating, windows, displays, pilot controls, and the like. A physical cockpit may be used to perform a simulated flight mission. Simulator module 248 and/or physical cockpit may include at least a pilot control configured to interface with a user. The pilot control may include any pilot control described in this disclosure. In some cases, at least one of simulator module 248, physical cockpit, and pilot control may include sensor 252. Sensor 252 may include any sensor as described herein. Sensor 252 may be communicatively connected to second computing device 260. Second computing device 260 may include any computing device as described herein.

With continued reference to FIG. 2, sensor 252 may be configured to detect input datum 256. Input datum 256 may include any input datum as described herein. In a non-limiting embodiment, sensor 252 may be configured to detect the same type of data as sensor 212. In a non-limiting embodiment, input datum 256 may be the same as input datum 216.

With continued reference to FIG. 2, first simulation device 204 may include second computing device 260, wherein second computing device 260 may be configured to generate second vehicle performance model output 268 as a function of input datum 256 using vehicle simulator 264. Vehicle simulator 264 may include any vehicle simulator as described herein. A “second vehicle performance model output,” for the purpose of this disclosure, is any simulation and/or model of a vehicle such as, but not limited to, an electric aircraft that embodies an analytical and/or interactive visualization regarding aircraft operation and/or performance capabilities of a second vehicle associated with second simulation device 244. In a non-limiting embodiment, vehicle simulator 264 may be configured to perform the same functions as vehicle simulator 224. In a non-limiting embodiment, second computing device 260 may be configured to perform the same and/or similar functions as first computing device 220.

With continued reference to FIG. 2, second computing device 260 may be configured to generate simulation datum 272. In a non-limiting embodiment, simulation datum 272 may be generated as a function of second vehicle performance model output 268 and input datum 256. Simulation datum 272 may be any simulation datum as described herein. In a non-limiting embodiment, second computing device 260 may be configured to receive altitude command datum 236 from first computing device 220 of first simulation device 204 to generate altitude function 276. An “altitude function,” for the purpose of this disclosure, is a responsive action representing the completion of altitude command datum 236. For example and without limitation, a trainer using first simulation device 204 may send over altitude command datum 236 to a trainee using second simulation device 244 and follow altitude command datum 236 in the form of altitude function 276. Communication between first simulation device 204 and second simulation device 224 may be performed instantaneously via a communication device and/or a network. In a non-limiting embodiment, user of second simulation device 244 may perform a torque allocation as a function of altitude command datum 236 and/or altitude function 276. A “torque allocation” as used in this disclosure is any distribution of a torque. For instance and without limitation, torque allocation performed by second computing device 260 and/or any computing device may be consistent with the description of torque allocation in U.S. patent application Ser. No. 17/197,427 filed on Mar. 10, 2021 and titled, “SYSTEM AND METHOD FOR FLIGHT CONTROL IN ELECTRIC AIRCRAFT”, which is incorporated herein in its entirety by reference. In a non-limiting illustrative example, torque allocation between two altitude control components (e.g., pitch and roll or roll and yaw) may be based on the relative priorities of those two altitude control components. Priority refers to how important to the safety of the aircraft and any users while performing the altitude control component may be relative to the other altitude control commands. Priority may also refer to the relative importance of each altitude control component to accomplish one or more desired aircraft maneuvers. For example, pitch altitude control component may be the highest priority, followed by roll, lift, and yaw altitude control components. In another example, the relative priority of the altitude components may be specific to an environment, aircraft maneuver, mission type, aircraft configuration, or other factors, to name a few. Torque allocator may set the highest priority altitude control component torque allocation as close as possible given the torque limits as described in this disclosure to the original command for the higher-priority altitude control component, in the illustrative example, pitch, then project to the value possible for the lower priority altitude control component, in this case, lift. The higher priority altitude control component in the first torque allocation may be the altitude control component with the highest overall priority. This process may be then repeated with lower priority altitude control component from the above comparison and the next highest down the priority list. In a non-limiting illustrative example, the next two-dimensional torque allocation problem solved would include lift and roll altitude control commands. In embodiments, the lower priority altitude command component has already been set form the previous two-dimensional torque allocation, so this may be projecting the closest possible value for the third-level altitude command (roll in this example). This process would repeat again for the third and fourth altitude components, in this non-limiting example, roll and yaw altitude control components. Since roll may be prioritized over yaw, the roll altitude control command would be preserved, and yaw would be sacrificed as a function of the vehicle torque limits as described herein. After the sequence of two-dimensional altitude control component torque allocation are completed and four prioritized altitude component commands are set, one or more components may send out commands to flight control surfaces/propulsors to generate the set torque values allocated in the foregoing process. For example and without limitation, the control allocation may be representative of altitude function 276. In a non-limiting embodiment, communication between any simulation device of a plurality of simulation device may be performed instantaneously as described herein.

With continued reference to FIG. 2, first simulation device 204 may include second display 280 communicatively connected to second computing device 260. In some cases, second display 280 may be configured to display at least a virtual representation of the second vehicle and/or second vehicle performance model output 268. Second display 280 may include any display as described herein.

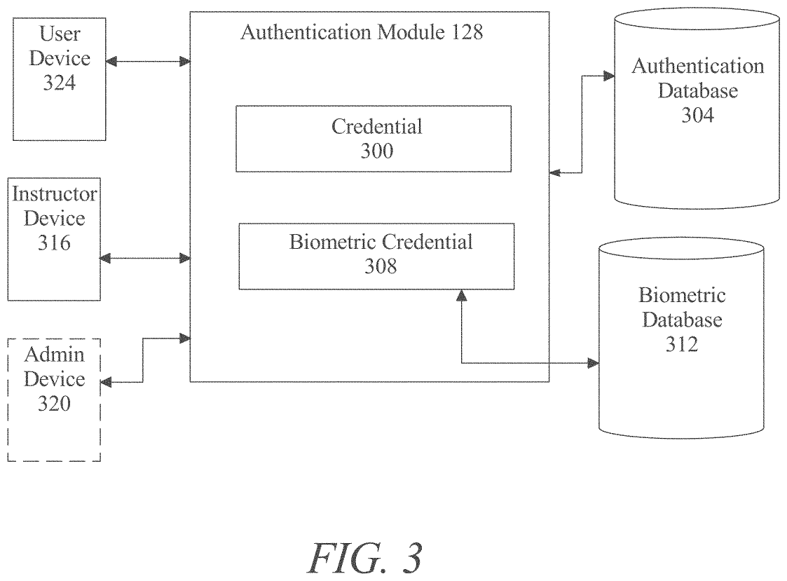

Referring now to FIG. 3, an embodiment of authentication module 128, as pictured in FIG. 1, is illustrated in detail. Authentication module 128 may include any suitable hardware and/or software module. Authentication module 128 and/or communication device 112 can be configured to authenticate user device 324. User device 324 may include any user device as described herein. In a non-limiting embodiment, user device 324 may include a user of a simulation device or just a simulation device. In a non-limiting embodiment, one user device may use authentication module 128 authenticate another user device. For instance and without limitation, if a user of a simulation device wanted to share data with another user of another simulation device, both users may use authentication module 128 to verify each other before allowing the sharing of data. For example and without limitation, a user acting as a trainee may authenticate another user acting as a trainer to provide real-time movement and perspective of the trainee's simulation to the trainer. The trainee may also give control of the trainee's simulation device and/or the trainee's simulated vehicle via authentication module 128 and at the request of the trainer. Authenticating, for example and without limitation, can include determining a user's ability/authorization to access information included in each module and/or engine of the plurality of modules and/or engines operating on communication device 112. As a further example and without limitation, authentication may include determining an instructor's authorization/ability of access to the information included in each module and/or engine of the plurality of modules and/or engines operating on communication device 112. As a further non-limiting example, authentication may include determining an administrator's authorization/ability to access the information included in each module and/or engine of the plurality of modules and/or engines operating on communication device 112. Authentication may enable access to an individual module and/or engine, a combination of modules and/or engines, and/or all the modules and/or engines operating on communication device 112. Authenticating user device 324 is configured to receive credential 300 from user device 324. Credential 300 may include any credential as described herein. For example and without limitation, credential 300 may include a username and password unique to the user and/or user device 324. As a further example and without limitation, credential 300 may include a PKI certificate unique to the user and/or user device 324. As a further embodiment, credential 300 may be received from instructor device 316 and/or admin device 320, such that credential 300 would authenticate each instructor device 316 and admin device 320, respectively. In a non-limiting embodiment, instructor device 316 may include a simulation device operated by a trainer. In a non-limiting embodiment, admin device 320 may include any admin device as described herein.

Continuing to refer to FIG. 3, authentication module 128 and/or communication device 112 may be further designed and configured to compare credential 300 from user device 324 to an authorized credential stored in authentication database 304. For example, authentication module 128 and/or communication device 112 may be configured to compare credential 300 from user device 324 to a stored authorized credential to determine if credential 300 matches the stored authorized credential. As a further embodiment, authentication module 128 and/or computing device may compare credential 300 from instructor device 316 to an authorized credential stored in authentication database 304. For example, authentication module 128 and/or computing device may be configured to compare credential 300 from instructor device 316 to a stored authorized credential to determine if credential 300 matches the stored authorized credential. As a further non-limiting example, authentication module 128 and/or computing device may match credential 300 from admin device 320 to an authorized credential stored in authentication database 304. For example, authentication module 128 and/or computing device may be configured to compare credential 300 from admin device 320 to a stored authorized credential to determine if credential 300 matches the stored authorized credential. In embodiments, comparing credential 300 to an authorized credential stored in authentication database 304 can include identifying an authorized credential stored in authentication database 304 by matching credential 300 to at least one authorized credential stored in authentication database 304. Authentication module 128 and/or computing device may include or communicate with authentication database 304. Authentication database 304 may be implemented as any database and/or datastore suitable for use as authentication database 304 as described in the entirety of this disclosure. The “authorized credential” as described in the entirety of this disclosure, is the unique identifier that will successfully authorize each user and/or user device 324 if received. For example and without limitation, the authorized credential is the correct alpha-numeric spelling, letter case, and special characters of the username and password for user device 324. Persons skilled in the art, upon reviewing the entirety of this disclosure, will be aware of various examples of authorized credentials that may be stored in the authentication database consistently with this disclosure.

Still referring to FIG. 3, authentication module 128 and/or communication device 112 is further designed and configured to bypass authentication for user device 324 based on the identification of the authorized credential stored within authentication database 304. Bypassing authentication may include permitting access to user device 324 to access the information included in each module and/or engine of the plurality of modules and/or engines operating on communication device 112. Bypassing authentication may enable access to an individual module and/or engine, a combination of modules and/or engines, and/or all the modules and/or engines operating on communication device 112, as described in further detail in the entirety of this disclosure. As a further example and without limitation, bypassing authentication may include bypassing authentication for instructor device 316 based on the comparison of the authorized credential stored in authentication database 304. As a further non-limiting example, bypassing authentication may include bypassing authentication for admin device 320 based on the comparison of the authorized credential stored in authentication database 348.

With continued reference to FIG. 3, authentication module 128 and/or communication device 112 may be further configured to biometrically authenticate user device 324. Biometric authentication, for example and without limitation, determines a user's ability to access the information included in each module and/or engine of the plurality of modules and/or engines operating on communication device 112 as a function of a biometric credential 308. Biometric authentication, in the embodiment, includes receiving biometric credential 308 from user device 324, comparing and/or matching biometric credential 308 from user device 324 to an authorized biometric credential stored in a biometric database 312, and bypassing authentication for user device 324 based on the comparison of the authorized biometric credential stored within biometric database 312. Biometric authentication employing authentication module 128 may also include biometrically authenticating instructor device 316 and/or admin device 320. Authentication module 128 and/or communication device 112 may include or communicate with biometric database 312. Biometric database 312 may be implemented as any database and/or datastore suitable for use as a biometric database entirely with this disclosure. The “biometric credential” as used in this disclosure, is any body measurement and/or calculation utilized for identification purposes, such as a physiological characteristic and/or behavioral characteristic. For example and without limitation, biometric credential 308 may include fingerprints, palm veins, face recognition, DNA, palm print, hand geometry, iris recognition, retina, odor/scent, typing rhythm, gait, voice, and the like. The “authorized biometric credential” as described in the entirety of this disclosure, is unique biometric identifier that will successfully authorize each user and/or user device 324, such that the authorized biometric credential is the correct biometric credential which will enable the user and/or user device 324 access to the plurality of modules and/or engines operating on communication device 112. Persons skilled in the art, upon reviewing the entirety of this disclosure, will be aware of various examples of biometric credentials and authorized biometric credentials that may be utilized by authentication module 128 consistently with this disclosure.

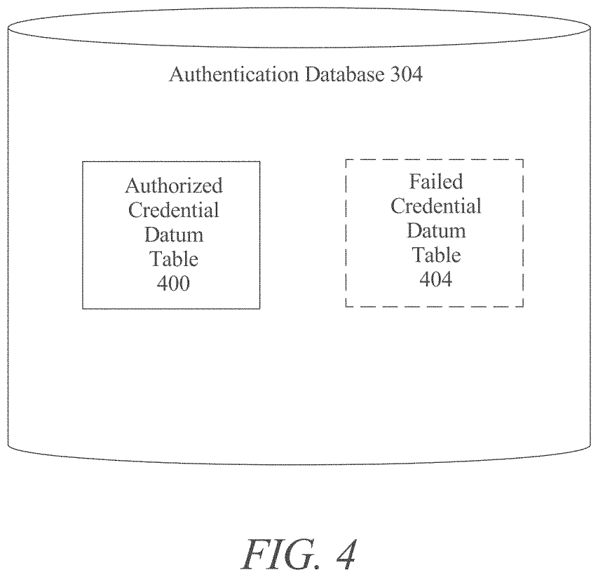

Referring now to FIG. 4, an embodiment of authentication database 304 is illustrated. Authentication database 304 may include any data structure for ordered storage and retrieval of data, which may be implemented as a hardware or software module. Authentication database 304 may be implemented, without limitation, as a relational database, a key-value retrieval datastore such as a NOSQL database, or any other format or structure for use as a datastore that a person skilled in the art would recognize as suitable upon review of the entirety of this disclosure. Authentication database 304 may include a plurality of data entries and/or records corresponding to credentials as described above. Data entries and/or records may describe, without limitation, data concerning authorized credential datum and failed credential datum.

With continued reference to FIG. 4, one or more database tables in authentication database 304 may include as a non-limiting example an authorized credential datum table 400. Authorized credential datum table 400 may be a table storing authorized credentials, wherein the authorized credentials may be for user device 324, instruction device 316 and/or admin device 320, as described in further detail in the entirety of this disclosure. For instance, and without limitation, authentication database 304 may include an authorized credential datum table 400 listing unique identifiers stored for user device 324, wherein the authorized credential is compared/matched to a credential 300 received from user device 324.

Still referring to FIG. 4, one or more database tables in authentication database 304 may include, as a non-limiting example, failed credential datum table 404. A “failed credential”, as described in the entirety of this disclosure, is a credential received from a device that did not match an authorized credential stored within authorized credential datum table 400 of authentication database 304. Such credentials can be received from user device 324, instruction device 316 and/or admin device 320. Failed credential datum table 404 may be a table storing and/or matching failed credentials. For instance and without limitation, authentication database 304 may include failed credential datum table 404 listing incorrect unique identifiers received by a device in authentication module 128, wherein authentication of the device did not result. Tables presented above are presented for exemplary purposes only; persons skilled in the art will be aware of various ways in which data may be organized in authentication database 304 consistently with this disclosure.

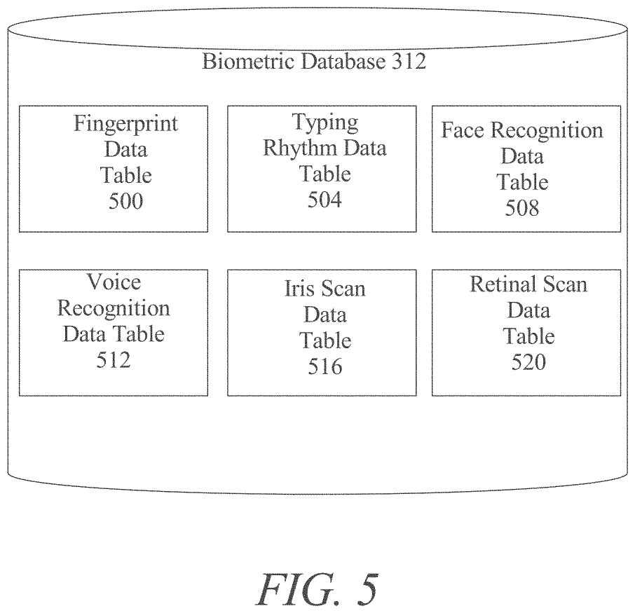

Referring now to FIG. 5, an embodiment of biometric database 312 is illustrated. Biometric database 312 may include any data structure for ordered storage and retrieval of data, which may be implemented as a hardware or software module. Biometric database 312 may be implemented, without limitation, as a relational database, a key-value retrieval datastore such as a NOSQL database, or any other format or structure for use as a datastore that a person skilled in the art would recognize as suitable upon review of the entirety of this disclosure. Biometric database 312 may include a plurality of data entries and/or records corresponding to elements of biometric datum as described above. Data entries and/or records may describe, without limitation, data concerning particular physiological characteristics and/or behavioral characteristics that have been collected. Data entries in a biometric database 312 may be flagged with or linked to one or more additional elements of information, which may be reflected in data entry cells and/or in linked tables such as tables related by one or more indices in a relational database; one or more additional elements of information may include data associating a biometric with one or more cohorts, including demographic groupings such as ethnicity, sex, age, income, geographical region, or the like. Additional elements of information may include one or more categories of biometric datum as described above. Persons skilled in the art, upon reviewing the entirety of this disclosure, will be aware of various ways in which data entries in a biometric database 312 may reflect categories, cohorts, and/or populations of data consistently with this disclosure.

Still referring to FIG. 5, one or more database tables in biometric database 312 may include, as a non-limiting example, fingerprint data table 500. Fingerprint data table 500 may be a table correlating, relating, and/or matching biometric credentials received from a device, such as user device 324, instructor device 316 and admin device 320, as described above, to fingerprint data. For instance, and without limitation, biometric database 312 may include a fingerprint data table 500 listing samples acquired from a user having allowed system 100 to retrieve fingerprint data from user device 324 through a fingerprint scanner, including biometric scanners such as optical scanners or capacitive scanners, one or more rows recording such an entry may be inserted in fingerprint data table 500.

With continued reference to FIG. 5, biometric database 312 may include tables listing one or more samples according to a sample source. For instance, and without limitation, biometric database 312 may include typing rhythm database 504 listing samples acquired from a user by obtaining the user's keystroke dynamics when typing characters on a keyboard and/or keypad, such as the time to get to and depress a key, duration the key is held down, use of caps-lock, pace of typing characters, misspellings, or the like. As another non-limiting example, biometric database 312 may include face recognition data table 508, which may list samples acquired from a user associated with user device 324 that has allowed system 100 to obtain digital images or video frames of the user's facial demographics, such as relative position, size, and/or shape of the eyes, nose, cheekbones, jaw, and/or the like. As a further non-limiting example, biometric database 312 may include a voice recognition data table 512, which may list samples acquired from a user associated with user device 324 that has allowed system 100 to retrieve the user's unique voice patterns though a microphone located on user device 324, such as dictation variants, common phrases, volume level, dialect, pitch, format frequencies, and/or the like. As a further example, also non-limiting, biometric database 312 may include iris scan data table 516, which may list samples acquired from a user associated with user device 324 that has allowed system 100 to retrieve a user's iris scan from a camera located on user device 324, including without limitation images of the detailed structures of the iris which are visible externally. As another non-limiting example, biometric database 312 may include retinal scan data table 520, which may include samples acquired from a user associated with user device 324 that has allowed system 100 to extract a user's retinal scan; retinal scans may include an image of the complex and unique structure of an individual's capillaries in the retina. Tables presented above are presented for exemplary purposes only; persons skilled in the art will be aware of various ways in which data may be organized in biometric database 312 consistently with this disclosure.

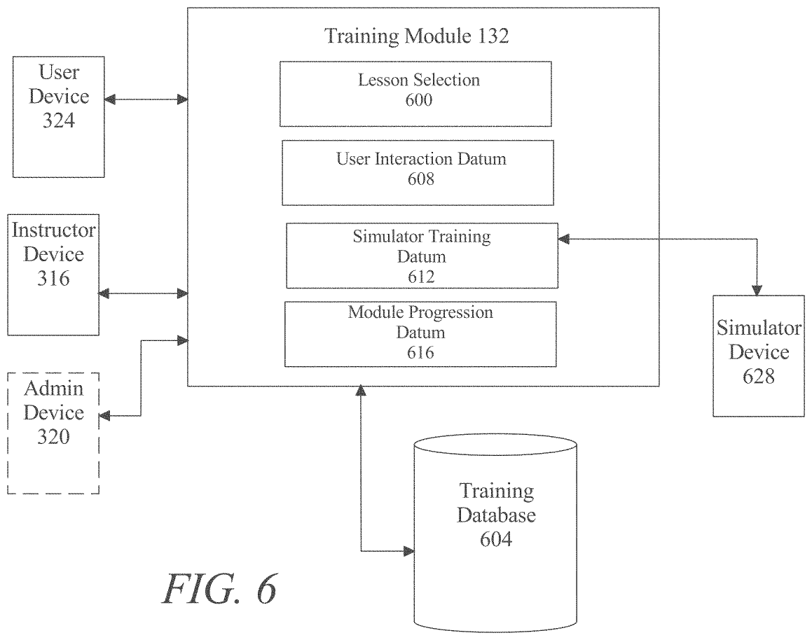

Referring now to FIG. 6, an embodiment of pilot training module 132, as pictured in FIG. 1, is illustrated in detail. Pilot training module 132 may include any suitable software and/or hardware module as described in the entirety of this disclosure. In an embodiment, pilot training module 132 and/or communication device 112 may be configured to receive a lesson selection 600 from user device 324. The “lesson selection” as used in the entirety of this disclosure, is the lesson module of the plurality of lesson modules user device 324 has selected to engage with. The lesson module may include any lesson module as described in the entirety of this disclosure. Lesson selection 600 may include a lesson and/or sub-topic of the coursework required to become an electric aircraft certified pilot. Receiving lesson selection from user device 324 may include selecting a lesson module from a drop-down menu of the plurality of lesson modules, a list, a visual display, and the like. Lesson selection 600 may include, as an example and without limitation, the lesson module next to complete in the electric aircraft pilot certification. As a further example and without limitation, lesson selection 600 may include the lesson module of the plurality of lesson modules that the user device was engaged with on the last authenticated use of system 100.

With continued reference to FIG. 6, pilot training module 132 and/or communication device 112 may be configured to transmit a plurality of lesson modules from training database 604 to user device 324 as a function of lesson selection 600. Pilot training module 132 and/or communication device 112 may include or communicate with training database 604. Training database 604 may be implemented as any database and/or datastore suitable for use as training database 604 as described in the entirety of this disclosure. Plurality of lesson modules may be a collection of data correlated to each course of the plurality of courses required to become a certified electric aircraft pilot. Each course of the plurality of courses may include, for example and without limitation, foundational knowledge, such as definitions, classifications, history and industry information, aircraft and pilot knowledge, such as aircraft instruments, aircraft systems, aeromedical factors and aeronautical decision making, flying environment knowledge, such as airspace, airports, aviation weather, and navigation, regulatory knowledge, such as aircraft classifications, federal aviation administration, flight schools, pilot certifications, in-flight knowledge, such as hovering maneuvers, vertical takeoff and landing, turning, instrument indicators, and emergency operations, and the like. Each lesson module of the plurality of lesson modules may include assessments and activities to be completed by the user utilizing user device 324, simulation device 628, a vehicle and/or simulated vehicle, and/or any combination thereof. Each lesson module may be designed to enable a user associated with user device 324 to become proficient at each course of the plurality of courses required to become a certified electric aircraft pilot. In an embodiment, the courses required to become a certified electric aircraft pilot may include any coursework from any aircraft certification and/or permission, such as, for example and without limitation, fixed conventional, fixed wing complex, light sport, private pilot, instrument, complex, multi-engine, high performance, tail wheel, sea plane, rotorcraft, powered lift, commercial, ATP, any combination thereof, and/or the like. Persons skilled in the art, upon reviewing the entirety of this disclosure, will be aware of various courses and/or coursework that may represent the plurality of lesson modules consistently with this disclosure.

Still referring to FIG. 6, pilot training module 132 and/or communication device 112 may be further configured to receive an interaction datum 608 from user device 324. Each interaction datum 608 correlates to a respective lesson module of the plurality of lesson modules, such that interaction datum 608 includes the latest interactions of user device 324 with pilot training module 132, including the data associated with the interaction, such as a mouse click, a gesture on a touch screen, a keyboard stroke, movement of an input device (e.g a joystick, switch, button, etc), voice command, or any combination thereof, to name a few. Each interaction datum 608 may include, for example and without limitation, an interaction with a displayed reading, activity, assessment, and the like. Each interaction datum 608 may include a set of answers for an assessment, a typographical entry correlating to an answer to a question, a video response, any combination thereof, and/or the like. An interaction datum 608 can be configured to correlate to the position of a user and/or user device 324 within the plurality of lesson modules. Pilot training module 132 and/or communication device 112 may be further configured to receive at least a simulator training datum 612 from simulation device 628. Simulation device 628 may include any simulation device as described in the entirety of this disclosure. In a non-limiting embodiment, simulation training datum 612 may include any simulation datum as described herein. Each simulator training datum 612 can be correlated to a respective lesson module of the plurality of lesson modules, such that the respective simulator training datum 612 includes the latest interactions of simulation device 628 with pilot training module 132, including the data associated with the interaction. A simulator training datum 612 may include, for example and without limitation, data associated with a simulation flight utilizing simulation device 628. The simulation flight utilizing simulation device 628 may be utilized as an assessment, practice, and the like. Simulator training datum 612 may also include, for example and without limitation, data representing an interaction with simulation device 628 wherein the user is performing a maneuver, skill, and/or technique included in each lesson module of the plurality of lesson modules. Simulator training datum 612 may further include any type of media, for example and without limitation, a video of the simulation flight, a textual summary of the simulator flight, a notification of a completed maneuver, and the like. The latest received simulator training datum 612 can be correlated with the position of the user and/or user device 324 within the plurality of lesson modules. Persons skilled in the art, upon reviewing the entirety of this disclosure, will be aware of various inputs that may represent the at least an interaction datum and the at least a simulator training datum consistently with this disclosure.

Continuing to refer to FIG. 6, pilot training module 132 and/or communication device 112 may be further configured to record a module progression datum 616 for user device 324 in training database 604 for each lesson module of the plurality of lesson modules as a function of the at least a user device interaction datum 608 and a simulator training datum 612. The “module progression datum” as described in the entirety of this disclosure, is the furthest point of progress of user device 324 of the plurality of modules for each authenticated use of user device 324 in system 100, including the data associated. Module progression datum 616 may include, for example and without limitation, data representing that user device 324 is halfway through an assignment of a lesson module of the plurality of lesson modules. For example and without limitation, module progression datum 616 may include three interaction datum 608 received from user device 324, however the lesson is not complete until two at least a simulator training datum 612 are received from simulation device 628. In the non-limiting example, pilot training module 132 will record module progression datum 616, detailing the progress of the user and/or user device 324, in training database 604. As a further example and without limitation, module progression datum 616 may include data representing that user device 324 is repeatedly failing a simulator maneuver assignment, such as when the user has to perform a specific technique in simulation device 628. Further module progression datum 616 can include data indicating that all required interaction datum 608 have been received from user device 324 but further that a simulator training datum 612 successfully performing the maneuver technique has not been received from simulation device 628. In embodiments, pilot training module 132 and/or communication device 112 can record module progression datum 616, detailing the progress of the user and/or user device of the particular lesson modules of the plurality of lesson modules, in training database 604. Persons skilled in the art, upon reviewing the entirety of this disclosure, will be aware of various datums that may represent the module progression datum consistently with this disclosure.

With continued reference to FIG. 6, in an embodiment, instructor device 316 may be configured to communicate with pilot training module 132 utilizing any means of communication as described in the entirety of this disclosure. Instructor device 316 may be configured to access any data tables and/or data set included in training database 604. Instructor device 316 may include any instructor device as described in the entirety of this disclosure. In an embodiment, admin device 320 may be configured to communicate with pilot training module 132 utilizing any means of communication as described in the entirety of this disclosure. Admin device 320 may be configured to access any data tables and/or data set included in training database 604 or other database associated with pilot training module 132.

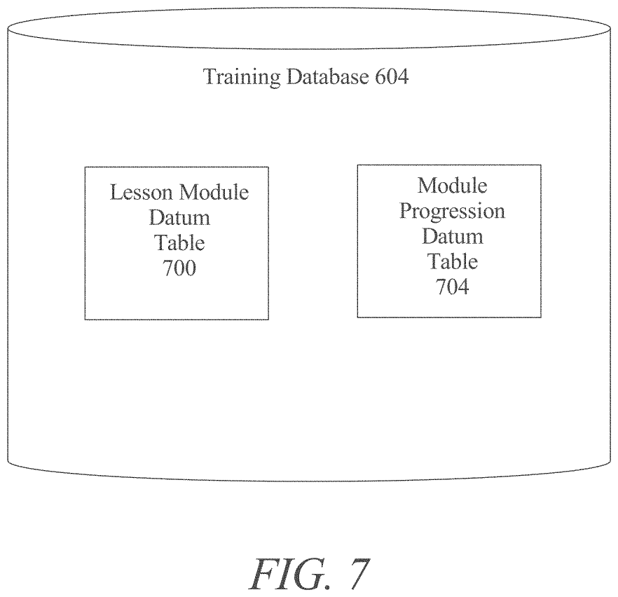

Referring now to FIG. 7, an embodiment of training database 604 is illustrated. Training database 604 may include any data structure for ordered storage and retrieval of data, which may be implemented as a hardware or software module. Training database 604 may be implemented, without limitation, as a relational database, a key-value retrieval datastore such as a NOSQL database, or any other format or structure for use as a datastore that a person skilled in the art would recognize as suitable upon review of the entirety of this disclosure. Training database 604 may include a plurality of data entries and/or records corresponding to verification elements as described above. Data entries and/or records may describe, without limitation, data concerning authentication datum and failed authentication datum.

Still referring to FIG. 7, one or more database tables in training database 604 may include, as a non-limiting example, a lesson module datum table 700. Lesson module datum table 700 may be a table storing the plurality of lesson modules. For instance, and without limitation, training database 604 may include a lesson module datum table 700 listing each lesson module of the plurality of lesson modules, the associated data of each lesson module, such as assignments, readings, assessments, and the like, the interaction datum 608, and the at least a simulator training datum 612.

Continuing to refer to FIG. 7, one or more database tables in training database 604 may include, as a non-limiting example, a module progression datum table 704. Module progression datum table 704 may be a table storing module progression datum 616 and/or associating lesson selection 600 to the stored module progression datum. For instance, and without limitation, training database 604 may include a module progression datum table 704 listing module progression datum 616 correlated to each lesson module of the plurality of lesson modules. Tables presented above are presented for exemplary purposes only; persons skilled in the art will be aware of various ways in which data may be organized in training database 604 consistently with this disclosure.

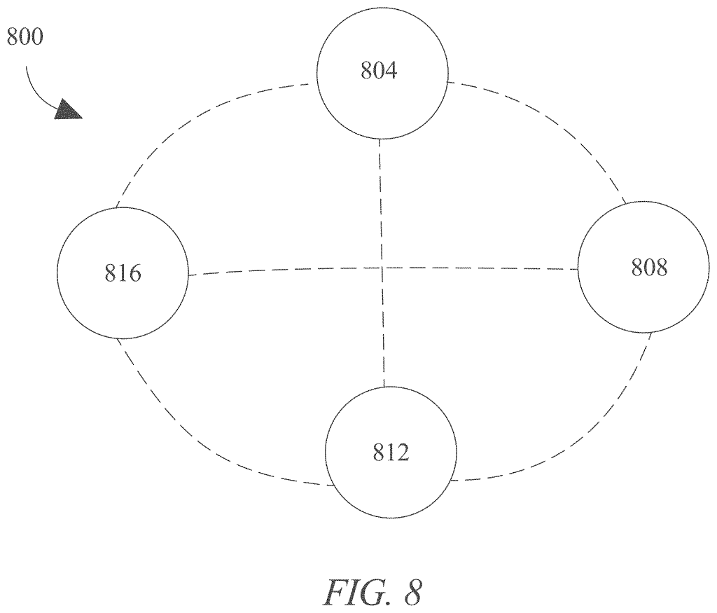

Referring now to FIG. 8, an exemplary embodiment of a system 800 for mesh network for a vehicle is illustrated. System 800 may include a mesh network for an electric aircraft. System 800 may include a node 804. Node 804 may include any computing device as described in this disclosure, including without limitation a microcontroller, microprocessor, digital signal processor (DSP) and/or system on a chip (SoC) as described in this disclosure. Node 804 may include, be included in, and/or communicate with a mobile device such as a mobile telephone or smartphone. Node 804 may include a single computing device operating independently, or may include two or more computing device operating in concert, in parallel, sequentially or the like; two or more computing devices may be included together in a single computing device or in two or more computing devices. Node 804 may interface or communicate with one or more additional devices as described below in further detail via a network interface device. Network interface device may be utilized for connecting node 804 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Node 804 may include but is not limited to, for example, a computing device or cluster of computing devices in a first location and a second computing device or cluster of computing devices in a second location. Node 804 may include one or more computing devices dedicated to data storage, security, distribution of traffic for load balancing, and the like. Node 804 may distribute one or more computing tasks as described below across a plurality of computing devices of computing device, which may operate in parallel, in series, redundantly, or in any other manner used for distribution of tasks or memory between computing devices. Node 804 may be implemented using a “shared nothing” architecture in which data is cached at the worker, in an embodiment, this may enable scalability of system 800 and/or computing device.

With continued reference to FIG. 8, node 804 may be designed and/or configured to perform any method, method step, or sequence of method steps in any embodiment described in this disclosure, in any order and with any degree of repetition. For instance, node 804 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Node 804 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 8, in some embodiments, system 800 may include a network topology. A “network topology” as used in this disclosure is an arrangement of elements of a communication network. In some embodiments, system 800 may include, but is not limited to, a star network, tree network, and/or a mesh network. A “mesh network” as used in this disclosure is a local network topology in which the infrastructure nodes connect directly, dynamically, and non-hierarchically to one or more other nodes. Nodes of system 800 may be configured to communicate in a partial mesh network. A partial mesh network may include a communication system in which some nodes may be connected directly to one another while other nodes may need to connect to at least another node to reach a third node. In some embodiments, system 800 may be configured to communicate in a full mesh network. A full mesh network may include a communication system in which every node in the network may communicate directly to one another. In some embodiments, system 800 may include a layered data network. As used in this disclosure a “layered data network” is a data network with a plurality of substantially independent communication layers with each configured to allow for data transfer over predetermined bandwidths and frequencies. As used in this disclosure a “layer” is a distinct and independent functional and procedural tool of transferring data from one location to another. For example, and without limitation, one layer may transmit communication data at a particular frequency range while another layer may transmit communication data at another frequency range such that there is substantially no cross-talk between the two layers which advantageously provides a redundancy and safeguard in the event of a disruption in the operation of one of the layers. A layer may be an abstraction which is not tangible.

Still referring to FIG. 8, in some embodiments, system 800 may include node 804, second node 808, third node 812, and/or fourth node 816. Node 804 may be configured to communicate with a first layer providing radio communication between nodes at a first bandwidth. In some embodiments, node 804 may be configured to communicate with a second layer providing mobile network communication between the nodes at a second bandwidth. In some embodiments, node 804 may be configured to communicate with a third layer providing satellite communication between the nodes at a third bandwidth. In some embodiments, any node of system 800 may be configured to communicate with any layer of communication. In some embodiments, a node of system 800 may include an antenna configured to provide radio communication between one or more nodes. For example, and without limitation, an antenna may include a directional antenna. In an embodiment, system 800 may include a first bandwidth, a second bandwidth, and a third bandwidth. In some embodiments, system 800 may include more or less than three bandwidths. In some embodiments, a first bandwidth may be greater than a second bandwidth and a third bandwidth. In some embodiments, system 800 may be configured to provide mobile network communication in the form a cellular network, such as, but not limited to, 8G, 3G, 4G, 5G, LTE, and/or other cellular network standards.

Still referring to FIG. 8, radio communication, in accordance with embodiments, may utilize at least a communication band and communication protocols suitable for aircraft radio communication. For example, and without limitation, a very-high-frequency (VHF) air band with frequencies between about 808 MHz and about 837 MHz may be utilized for radio communication. In another example, and without limitation, frequencies in the Gigahertz range may be utilized. Airband or aircraft band is the name for a group of frequencies in the VHF radio spectrum allocated to radio communication in civil aviation, sometimes also referred to as VHF, or phonetically as “Victor”. Different sections of the band are used for radio-navigational aids and air traffic control. Radio communication protocols for aircraft are typically governed by the regulations of the Federal Aviation Authority (FAA) in the United States and by other regulatory authorities internationally. Radio communication protocols may employ, for example and without limitation an S band with frequencies in the range from about 8 GHz to about 4 GHz. For example, and without limitation, for 4G mobile network communication frequency bands in the range of about 8 GHz to about 8 GHz may be utilized, and for 5G mobile network communication frequency bands in the ranges of about 450 MHz to about 6 GHz and of about 84 GHz to about 53 GHz may be utilized. Mobile network communication may utilize, for example and without limitation, a mobile network protocol that allows users to move from one network to another with the same IP address. In some embodiments, a node of system 800 may be configured to transmit and/or receive a radio frequency transmission signal. A “radio frequency transmission signal,” as used in this disclosure, is an alternating electric current or voltage or of a magnetic, electric, or electromagnetic field or mechanical system in the frequency range from approximately 80 kHz to approximately 300 GHz. A radio frequency (RF) transmission signal may compose an analogue and/or digital signal received and be transmitted using functionality of output power of radio frequency from a transmitter to an antenna, and/or any RF receiver. A RF transmission signal may use longwave transmitter device for transmission of signals. An RF transmission signal may include a variety of frequency ranges, wavelength ranges, ITU designations, and IEEE bands including HF, VHF, UHF, L, S, C, X, Ku, K, Ka, V, W, mm, among others.

Still referring to FIG. 8, satellite communication, in accordance with embodiments, may utilize at least a communication band and communication protocols suitable for aircraft satellite communication. For example, and without limitation, satellite communication bands may include L-band (1-2 GHz), C-band (4-8 GHz), X-band (8-12 GHz), Ku-band (12-18 GHz), Ku-band (12-18 GHz), and the like, among others. Satellite communication protocols may employ, for example and without limitation, a Secondary Surveillance Radar (SSR) system, automated dependent surveillance-broadcast (ADS-B) system, or the like. In SSR, radar stations may use radar to interrogate transponders attached to or contained in aircraft and receive information in response describing such information as aircraft identity, codes describing flight plans, codes describing destination, and the like SSR may utilize any suitable interrogation mode, including Mode S interrogation for generalized information. ADS-B may implement two communication protocols, ADS-B-Out and ADS-B-In. ADS-B-Out may transmit aircraft position and ADS-B-In may receive aircraft position. Radio communication equipment may include any equipment suitable to carry on communication via electromagnetic waves at a particular bandwidth or bandwidth range, for example and without limitation, a receiver, a transmitter, a transceiver, an antenna, an aerial, and the like, among others. A mobile or cellular network communication equipment may include any equipment suitable to carry on communication via electromagnetic waves at a particular bandwidth or bandwidth range, for example and without limitation, a cellular phone, a smart phone, a personal digital assistant (PDA), a tablet, an antenna, an aerial, and the like, among others. A satellite communication equipment may include any equipment suitable to carry on communication via electromagnetic waves at a particular bandwidth or bandwidth range, for example and without limitation, a satellite data unit, an amplifier, an antenna, an aerial, and the like, among others.

Still referring to FIG. 8, as used in this disclosure “bandwidth” is measured as the amount of data that can be transferred from one point or location to another in a specific amount of time. The points or locations may be within a given network. Typically, bandwidth is expressed as a bitrate and measured in bits per second (bps). In some instances, bandwidth may also indicate a range within a band of wavelengths, frequencies, or energies, for example and without limitation, a range of radio frequencies which is utilized for a particular communication.

Still referring to FIG. 8, as used in this disclosure “antenna” is a rod, wire, aerial or other device used to transmit or receive signals such as, without limitation, radio signals and the like. A “directional antenna” or beam antenna is an antenna which radiates or receives greater power in specific directions allowing increased performance and reduced interference from unwanted sources. Typical examples of directional antennas include the Yagi antenna, the log-periodic antenna, and the corner reflector antenna. The directional antenna may include a high-gain antenna (HGA) which is a directional antenna with a focused, narrow radio wave beamwidth and a low-gain antenna (LGA) which is an omnidirectional antenna with a broad radio wave beamwidth, as needed or desired.

With continued reference to FIG. 8, as used in this disclosure, a “signal” is any intelligible representation of data, for example from one device to another. A signal may include an optical signal, a hydraulic signal, a pneumatic signal, a mechanical, signal, an electric signal, a digital signal, an analog signal and the like. In some cases, a signal may be used to communicate with a computing device, for example by way of one or more ports. In some cases, a signal may be transmitted and/or received by a computing device for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 828 [printer port]), and the like.

Still referring to FIG. 8, in some cases, a node of system 800 may perform one or more signal processing steps on a sensed characteristic. For instance, a node may analyze, modify, and/or synthesize a signal representative of characteristic in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

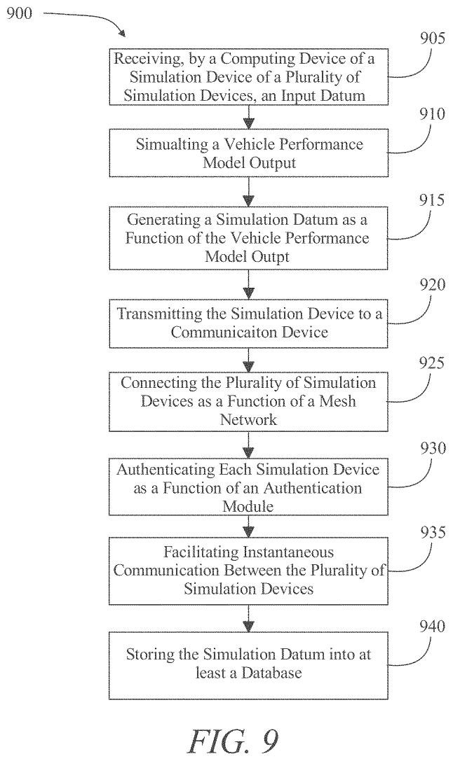

Referring now to FIG. 9, a flow diagram of an exemplary method 900 for instantaneous communication between simulators is provided. Method 900, at step 905, may include receiving, by a computing device of a simulation device of a plurality of simulation devices, an input datum. The computing device may include any computing device as described herein. In a non-limiting embodiment. The input datum may include any input datum as described herein. simulation device may include any simulation device as described herein. In a non-limiting embodiment, each simulation device may be operated independently by a user. In a non-limiting embodiment, a first simulation device may be configured to simulate an operation of a vehicle while a second simulation device may be configured to simulate an operation of another vehicle. For example and without limitation, both simulations generated from the first simulation device and the second simulation device may interact with each other in the simulation. For example and without limitation, the first simulation device and the second simulation device may be configured to simulate vehicle operations in the same simulated reality world as a function of a network. The simulated reality world may be consistent with any simulated reality world as described herein. Persons skilled in the art, upon reviewing the entirety of this disclosure, will be aware of the various embodiments of simulated reality in which users may interact in simulation for purposes as described herein. In a non-limiting embodiment, method 900, at step 905, may include receiving any datum instantaneously. Persons skilled in the art, upon reviewing the entirety of this disclosure, will be aware of the various methods of receiving any data for the purposes of simulation as described herein.

With continued reference to FIG. 9, method 900, at step 910, may include simulating a vehicle performance model output. The vehicle performance model output may include any vehicle performance model output as described herein. In a non-limiting embodiment, method 900, at step 910, may include simulating as a function of a vehicle simulator. In a non-limiting embodiment, the simulation may include a digital twin or simulation of any vehicle such as an electric aircraft. The vehicle simulator may include any vehicle simulator as described herein. In a non-limiting embodiment, method 900, at step 910, may include simulating the vehicle performance model output as a function of a user operating a simulation module. The simulation module may include any simulation module as described herein. In a non-limiting embodiment, step 910 may include translating any user movement operating the simulation module into an input datum. For example and without limitation, simulation module may include an imitation of a cockpit of an aircraft. In a non-limiting embodiment, the vehicle performance model output may include a virtual representation of any vehicle or aircraft. The virtual representation may include any virtual representation as described herein. Persons skilled in the art, upon reviewing the entirety of this disclosure, will be aware of the various embodiments and methods of simulating a digital version of a vehicle for purposes as described herein.

With continued reference to FIG. 9, method 900, at step 915, may include generating a simulation datum as a function of the performance model output. The simulation datum may include any simulation described herein. In a non-limiting embodiment, step 915 may include generating a machine-learning model configured to use a training data from a machine-learning algorithm and inputs such as the input datum and output the simulation datum. The machine-learning model may include any machine-learning model as described herein. The machine-learning algorithm may include any machine-learning algorithm as described herein. The training data may include any training data as described herein. In a non-limiting embodiment, step 915 may include retrieving the training data from a local database and/or a cloud database. In a non-limiting embodiment, step 915 may include generating an altitude command datum. The altitude command datum may include any altitude command datum.

With continued reference to FIG. 9, method 900, at step 920, may include transmitting the simulation datum to a communication device. The communication device may include any communication device as described herein. In a non-limiting embodiment, step 920 may include transmitting the simulation datum as a function of any digital connection. For example and without limitation, transmitting may include transmitting via a network connection. In a non-limiting embodiment, transmitting may include transmitting signals via physical CAN bus units. The physical CAN bus units may be consistent with any physical CAN bus unit as described herein. In a non-limiting embodiment, a simulation device may transmit any datum to another simulation device as long as both simulation devices are connected via a network connection, such as an internet connection. For example and without limitation, each simulation device's simulated vehicle may be configured to interact with each other in the simulated reality world and transmit any datum that imitates the real-life communication that the simulated vehicles are imitating. Persons skilled in the art, upon reviewing the entirety of this disclosure, will be aware various methods of transmission within a simulated setting for purposes as described herein.

With continued reference to FIG. 9, method 900, at step 925, may include communicatively connecting the plurality of simulation devices as a function of a mesh network. The mesh network may include any network and/or mesh network as described herein. In a non-limiting embodiment, step 925 may include connecting as a function of an avionics mesh network. The avionics mesh network may be consistent with any avionics mesh network as described herein. In a non-limiting embodiment, step 925 may include connecting as a function of the communication device. For example and without limitation, the communication device may be configured to create the network in which the simulated reality world may exist, and the simulation devices may interact with each other. In a non-limiting embodiment, step 925 may include connecting the plurality of simulation devices via the network wherein each simulation device is located in isolation from each other. In a non-limiting embodiment, connecting may include using a plurality of communication components of the communication device in which each simulation device within the network and/or simulate reality world is associated to a communication component of the communication device wherein the communication components are configured to transfer data between each other. Persons skilled in the art, upon reviewing the entirety of this disclosure, will be aware of the various methods of connecting via network for purposes as described herein.

With continued reference to FIG. 9, method 900, at step 930, may include authenticating each simulation device as a function of an authentication module. Authentication module may include any authentication module as described herein. In a non-limiting embodiment, step 930 may include authenticating any simulation device. For example and without limitation, other simulation devices may connect via the network at the approval of the authentication module in which those simulation devices may join other simulation devices within the simulated reality world. In a non-limiting embodiment, step 930 may include authenticating a first simulation device before communicating with a second simulation device in the simulated reality world. For example and without limitation, a trainer and/or instructor may request to view the real-time movements of a trainee's simulated vehicle in which the authentication module may be used to authenticate the trainer before allowing the trainer to have access to those real-time movements. For example and without limitation, the trainer may also request control of the trainee's simulated vehicle in order to enhance a training experience. Persons skilled in the art, upon reviewing the entirety of this disclosure, will be aware of the various embodiments and methods for simulated training for purposes as described herein.

With continued reference to FIG. 9, method 900, at step 935, may include facilitating, by each communication component of a plurality of communication components of the communication device, instantaneous communication between the plurality of simulation devices. In a non-limiting embodiment, step 935 may include using an automated broadcaster or at least a simulated and/or virtual representation of an automated broadcaster to facilitate communication between simulated vehicles operated by users of simulation devices. In a non-limiting embodiment, such communication may be configured to replicate or imitate real-life communication of vehicles in operation. Persons skilled in the art, upon reviewing the entirety of this disclosure, will be aware of the various methods and embodiments that may be used to facilitate or imitate facilitation for purposes as described herein.

With continued reference to FIG. 9, method 900, at step 940, may include storing the simulation datum into at least a database. The at least a database may include a local database and a cloud database. The local database may include any local database as described herein. The cloud database may include any cloud database as described herein. In a non-limiting embodiment, each simulation device may store any data it may detect or generate into a local database in the event it loses connection with the network of the simulated reality world or a connection with another simulation device. In a non-limiting embodiment, each simulation device may have an associated local database to store data into. In a non-limiting embodiment, step 940 may include storing any datum received by the network and/or communication device into the cloud database. In a non-limiting embodiment, the cloud database may be accessed by any simulation device within the network or at least connected to the network. Persons skilled in the art, upon reviewing the entirety of this disclosure, will be aware of the various methods and embodiments for storing data locally and through cloud for purposes as described herein.

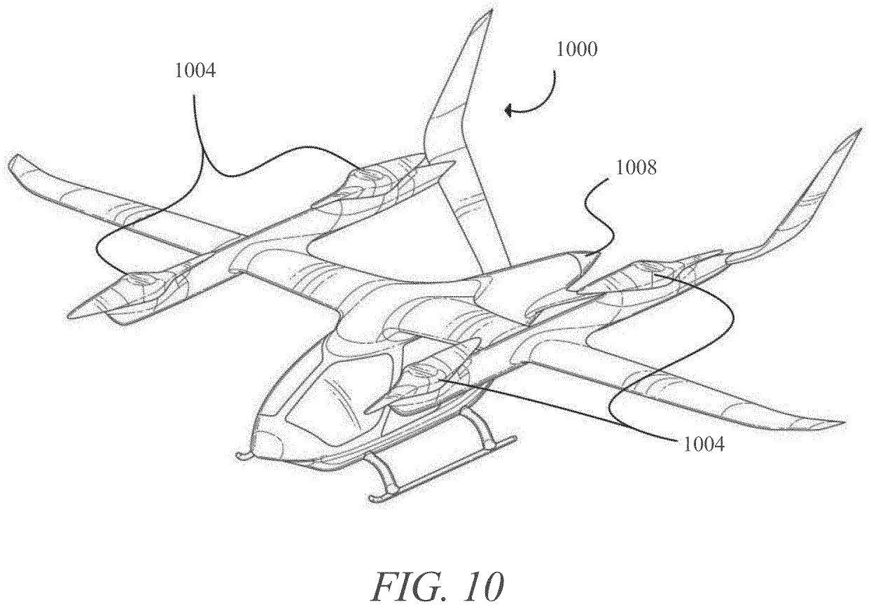

Referring now to FIG. 10, an exemplary embodiment of an aircraft 1000, which may include, or be incorporated with, a system for optimization of a recharging flight plan is illustrated. As used in this disclosure an “aircraft” is any vehicle that may fly by gaining support from the air. As a non-limiting example, aircraft may include airplanes, helicopters, commercial and/or recreational aircrafts, instrument flight aircrafts, drones, electric aircrafts, airliners, rotorcrafts, vertical takeoff and landing aircrafts, jets, airships, blimps, gliders, paramotors, and the like thereof.

Still referring to FIG. 10, aircraft 1000 may include an electrically powered aircraft. In embodiments, electrically powered aircraft may be an electric vertical takeoff and landing (eVTOL) aircraft. Aircraft 1000 may include an unmanned aerial vehicle and/or a drone. Electric aircraft may be capable of rotor-based cruising flight, rotor-based takeoff, rotor-based landing, fixed-wing cruising flight, airplane-style takeoff, airplane-style landing, and/or any combination thereof. Electric aircraft may include one or more manned and/or unmanned aircrafts. Electric aircraft may include one or more all-electric short takeoff and landing (eSTOL) aircrafts. For example, and without limitation, eSTOL aircrafts may accelerate the plane to a flight speed on takeoff and decelerate the plane after landing. In an embodiment, and without limitation, electric aircraft may be configured with an electric propulsion assembly. Electric propulsion assembly may include any electric propulsion assembly as described in U.S. Nonprovisional application Ser. No. 16/703,225, and entitled “AN INTEGRATED ELECTRIC PROPULSION ASSEMBLY,” the entirety of which is incorporated herein by reference. For purposes of description herein, the terms “upper”, “lower”, “left”, “rear”, “right”, “front”, “vertical”, “horizontal”, “upward”, “downward”, “forward”, “backward” and derivatives thereof shall relate to the invention as oriented in FIG. 10.

Still referring to FIG. 10, aircraft 1000 includes a fuselage 1004. As used in this disclosure a “fuselage” is the main body of an aircraft, or in other words, the entirety of the aircraft except for the cockpit, nose, wings, empennage, nacelles, any and all control surfaces, and generally contains an aircraft's payload. Fuselage 1004 may include structural elements that physically support a shape and structure of an aircraft. Structural elements may take a plurality of forms, alone or in combination with other types. Structural elements may vary depending on a construction type of aircraft such as without limitation a fuselage 1004. Fuselage 1004 may comprise a truss structure. A truss structure may be used with a lightweight aircraft and comprises welded steel tube trusses. A “truss,” as used in this disclosure, is an assembly of beams that create a rigid structure, often in combinations of triangles to create three-dimensional shapes. A truss structure may alternatively comprise wood construction in place of steel tubes, or a combination thereof. In embodiments, structural elements may comprise steel tubes and/or wood beams. In an embodiment, and without limitation, structural elements may include an aircraft skin. Aircraft skin may be layered over the body shape constructed by trusses. Aircraft skin may comprise a plurality of materials such as plywood sheets, aluminum, fiberglass, and/or carbon fiber, the latter of which will be addressed in greater detail later herein.

In embodiments, and with continued reference to FIG. 10, aircraft fuselage 1004 may include and/or be constructed using geodesic construction. Geodesic structural elements may include stringers wound about formers (which may be alternatively called station frames) in opposing spiral directions. A “stringer,” as used in this disclosure, is a general structural element that includes a long, thin, and rigid strip of metal or wood that is mechanically coupled to and spans a distance from, station frame to station frame to create an internal skeleton on which to mechanically couple aircraft skin. A former (or station frame) may include a rigid structural element that is disposed along a length of an interior of aircraft fuselage 1004 orthogonal to a longitudinal (nose to tail) axis of the aircraft and may form a general shape of fuselage 1004. A former may include differing cross-sectional shapes at differing locations along fuselage 1004, as the former is the structural element that informs the overall shape of a fuselage 1004 curvature. In embodiments, aircraft skin may be anchored to formers and strings such that the outer mold line of a volume encapsulated by formers and stringers comprises the same shape as aircraft 1000 when installed. In other words, former(s) may form a fuselage's ribs, and the stringers may form the interstitials between such ribs. The spiral orientation of stringers about formers may provide uniform robustness at any point on an aircraft fuselage such that if a portion sustains damage, another portion may remain largely unaffected. Aircraft skin may be mechanically coupled to underlying stringers and formers and may interact with a fluid, such as air, to generate lift and perform maneuvers.

In an embodiment, and still referring to FIG. 10, fuselage 1004 may include and/or be constructed using monocoque construction. Monocoque construction may include a primary structure that forms a shell (or skin in an aircraft's case) and supports physical loads. Monocoque fuselages are fuselages in which the aircraft skin or shell is also the primary structure. In monocoque construction aircraft skin would support tensile and compressive loads within itself and true monocoque aircraft can be further characterized by the absence of internal structural elements. Aircraft skin in this construction method is rigid and can sustain its shape with no structural assistance form underlying skeleton-like elements. Monocoque fuselage may comprise aircraft skin made from plywood layered in varying grain directions, epoxy-impregnated fiberglass, carbon fiber, or any combination thereof.

According to embodiments, and further referring to FIG. 10, fuselage 1004 may include a semi-monocoque construction. Semi-monocoque construction, as used herein, is a partial monocoque construction, wherein a monocoque construction is describe above detail. In semi-monocoque construction, aircraft fuselage 1004 may derive some structural support from stressed aircraft skin and some structural support from underlying frame structure made of structural elements. Formers or station frames can be seen running transverse to the long axis of fuselage 1004 with circular cutouts which are generally used in real-world manufacturing for weight savings and for the routing of electrical harnesses and other modern on-board systems. In a semi-monocoque construction, stringers are thin, long strips of material that run parallel to fuselage's long axis. Stringers may be mechanically coupled to formers permanently, such as with rivets. Aircraft skin may be mechanically coupled to stringers and formers permanently, such as by rivets as well. A person of ordinary skill in the art will appreciate, upon reviewing the entirety of this disclosure, that there are numerous methods for mechanical fastening of the aforementioned components like screws, nails, dowels, pins, anchors, adhesives like glue or epoxy, or bolts and nuts, to name a few. A subset of fuselage under the umbrella of semi-monocoque construction includes unibody vehicles. Unibody, which is short for “unitized body” or alternatively “unitary construction”, vehicles are characterized by a construction in which the body, floor plan, and chassis form a single structure. In the aircraft world, unibody may be characterized by internal structural elements like formers and stringers being constructed in one piece, integral to the aircraft skin as well as any floor construction like a deck.

Still referring to FIG. 10, stringers and formers, which may account for the bulk of an aircraft structure excluding monocoque construction, may be arranged in a plurality of orientations depending on aircraft operation and materials. Stringers may be arranged to carry axial (tensile or compressive), shear, bending or torsion forces throughout their overall structure. Due to their coupling to aircraft skin, aerodynamic forces exerted on aircraft skin will be transferred to stringers. A location of said stringers greatly informs the type of forces and loads applied to each and every stringer, all of which may be handled by material selection, cross-sectional area, and mechanical coupling methods of each member. A similar assessment may be made for formers. In general, formers may be significantly larger in cross-sectional area and thickness, depending on location, than stringers. Both stringers and formers may comprise aluminum, aluminum alloys, graphite epoxy composite, steel alloys, titanium, or an undisclosed material alone or in combination.

In an embodiment, and still referring to FIG. 10, stressed skin, when used in semi-monocoque construction is the concept where the skin of an aircraft bears partial, yet significant, load in an overall structural hierarchy. In other words, an internal structure, whether it be a frame of welded tubes, formers and stringers, or some combination, may not be sufficiently strong enough by design to bear all loads. The concept of stressed skin may be applied in monocoque and semi-monocoque construction methods of fuselage 1004. Monocoque comprises only structural skin, and in that sense, aircraft skin undergoes stress by applied aerodynamic fluids imparted by the fluid. Stress as used in continuum mechanics may be described in pound-force per square inch (lbf/in²) or Pascals (Pa). In semi-monocoque construction stressed skin may bear part of aerodynamic loads and additionally may impart force on an underlying structure of stringers and formers.

Still referring to FIG. 10, it should be noted that an illustrative embodiment is presented only, and this disclosure in no way limits the form or construction method of a system and method for loading payload into an eVTOL aircraft. In embodiments, fuselage 1004 may be configurable based on the needs of the eVTOL per specific mission or objective. The general arrangement of components, structural elements, and hardware associated with storing and/or moving a payload may be added or removed from fuselage 1004 as needed, whether it is stowed manually, automatedly, or removed by personnel altogether. Fuselage 1004 may be configurable for a plurality of storage options. Bulkheads and dividers may be installed and uninstalled as needed, as well as longitudinal dividers where necessary. Bulkheads and dividers may be installed using integrated slots and hooks, tabs, boss and channel, or hardware like bolts, nuts, screws, nails, clips, pins, and/or dowels, to name a few. Fuselage 1004 may also be configurable to accept certain specific cargo containers, or a receptable that can, in turn, accept certain cargo containers.

Still referring to FIG. 10, aircraft 1000 may include a plurality of laterally extending elements attached to fuselage 1004. As used in this disclosure a “laterally extending element” is an element that projects essentially horizontally from fuselage, including an outrigger, a spar, and/or a fixed wing that extends from fuselage. Wings may be structures which include airfoils configured to create a pressure differential resulting in lift. Wings may generally dispose on the left and right sides of the aircraft symmetrically, at a point between nose and empennage. Wings may comprise a plurality of geometries in planform view, swept swing, tapered, variable wing, triangular, oblong, elliptical, square, among others. A wing's cross section geometry may comprise an airfoil. An “airfoil” as used in this disclosure is a shape specifically designed such that a fluid flowing above and below it exert differing levels of pressure against the top and bottom surface. In embodiments, the bottom surface of an aircraft can be configured to generate a greater pressure than does the top, resulting in lift. Laterally extending element may comprise differing and/or similar cross-sectional geometries over its cord length or the length from wing tip to where wing meets the aircraft's body. One or more wings may be symmetrical about the aircraft's longitudinal plane, which comprises the longitudinal or roll axis reaching down the center of the aircraft through the nose and empennage, and the plane's yaw axis. Laterally extending element may comprise controls surfaces configured to be commanded by a pilot or pilots to change a wing's geometry and therefore its interaction with a fluid medium, like air. Control surfaces may comprise flaps, ailerons, tabs, spoilers, and slats, among others. The control surfaces may dispose on the wings in a plurality of locations and arrangements and in embodiments may be disposed at the leading and trailing edges of the wings, and may be configured to deflect up, down, forward, aft, or a combination thereof. An aircraft, including a dual-mode aircraft may comprise a combination of control surfaces to perform maneuvers while flying or on ground.

Still referring to FIG. 10, aircraft 1000 includes a plurality of flight components 1008. As used in this disclosure a “flight component” is a component that promotes flight and guidance of an aircraft. In an embodiment, flight component 1008 may be mechanically coupled to an aircraft. As used herein, a person of ordinary skill in the art would understand “mechanically coupled” to mean that at least a portion of a device, component, or circuit is connected to at least a portion of the aircraft via a mechanical coupling. Said mechanical coupling can include, for example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, hirth joints, hydrodynamic coupling, jaw coupling, magnetic coupling, Oldham coupling, sleeve coupling, tapered shaft lock, twin spring coupling, rag joint coupling, universal joints, or any combination thereof. In an embodiment, mechanical coupling may be used to connect the ends of adjacent parts and/or objects of an electric aircraft. Further, in an embodiment, mechanical coupling may be used to join two pieces of rotating electric aircraft components.

Still referring to FIG. 10, plurality of flight components 1008 may include at least a lift propulsor component 1012. As used in this disclosure a “lift propulsor component” is a component and/or device used to propel a craft upward by exerting downward force on a fluid medium, which may include a gaseous medium such as air or a liquid medium such as water. Lift propulsor component 1012 may include any device or component that consumes electrical power on demand to propel an electric aircraft in a direction or other vehicle while on ground or in-flight. For example, and without limitation, lift propulsor component 1012 may include a rotor, propeller, paddle wheel and the like thereof, wherein a rotor is a component that produces torque along the longitudinal axis, and a propeller produces torquer along the vertical axis. In an embodiment, lift propulsor component 1012 includes a plurality of blades. As used in this disclosure a “blade” is a propeller that converts rotary motion from an engine or other power source into a swirling slipstream. In an embodiment, blade may convert rotary motion to push the propeller forwards or backwards. In an embodiment lift propulsor component 1012 may include a rotating power-driven hub, to which are attached several radial airfoil-section blades such that the whole assembly rotates about a longitudinal axis. Blades may be configured at an angle of attack, wherein an angle of attack is described in detail below. In an embodiment, and without limitation, angle of attack may include a fixed angle of attack. As used in this disclosure a “fixed angle of attack” is fixed angle between a chord line of a blade and relative wind. As used in this disclosure a “fixed angle” is an angle that is secured and/or unmovable from the attachment point. For example, and without limitation fixed angle of attack may be 3.2° as a function of a pitch angle of 19.7° and a relative wind angle 16.5°. In another embodiment, and without limitation, angle of attack may include a variable angle of attack. As used in this disclosure a “variable angle of attack” is a variable and/or moveable angle between a chord line of a blade and relative wind. As used in this disclosure a “variable angle” is an angle that is moveable from an attachment point. For example, and without limitation variable angle of attack may be a first angle of 10.7° as a function of a pitch angle of 17.1° and a relative wind angle 16.4°, wherein the angle adjusts and/or shifts to a second angle of 16.7° as a function of a pitch angle of 16.1° and a relative wind angle 16.4°. In an embodiment, angle of attack be configured to produce a fixed pitch angle. As used in this disclosure a “fixed pitch angle” is a fixed angle between a cord line of a blade and the rotational velocity direction. For example, and without limitation, fixed pitch angle may include 18°. In another embodiment fixed angle of attack may be manually variable to a few set positions to adjust one or more lifts of the aircraft prior to flight. In an embodiment, blades for an aircraft are designed to be fixed to their hub at an angle similar to the thread on a screw makes an angle to the shaft; this angle may be referred to as a pitch or pitch angle which will determine a speed of forward movement as the blade rotates.

In an embodiment, and still referring to FIG. 10, lift propulsor component 1012 may be configured to produce a lift. As used in this disclosure a “lift” is a perpendicular force to the oncoming flow direction of fluid surrounding the surface. For example, and without limitation relative air speed may be horizontal to aircraft 1000, wherein lift force may be a force exerted in a vertical direction, directing aircraft 1000 upwards. In an embodiment, and without limitation, lift propulsor component 1012 may produce lift as a function of applying a torque to lift propulsor component. As used in this disclosure a “torque” is a measure of force that causes an object to rotate about an axis in a direction. For example, and without limitation, torque may rotate an aileron and/or rudder to generate a force that may adjust and/or affect altitude, airspeed velocity, groundspeed velocity, direction during flight, and/or thrust. For example, one or more flight components such as a power sources may apply a torque on lift propulsor component 1012 to produce lift. As used in this disclosure a “power source” is a source that that drives and/or controls any other flight component. For example, and without limitation power source may include a motor that operates to move one or more lift propulsor components, to drive one or more blades, or the like thereof. A motor may be driven by direct current (DC) electric power and may include, without limitation, brushless DC electric motors, switched reluctance motors, induction motors, or any combination thereof. A motor may also include electronic speed controllers or other components for regulating motor speed, rotation direction, and/or dynamic braking.

Still referring to FIG. 10, power source may include an energy source. An energy source may include, for example, an electrical energy source a generator, a photovoltaic device, a fuel cell such as a hydrogen fuel cell, direct methanol fuel cell, and/or solid oxide fuel cell, an electric energy storage device (e.g., a capacitor, an inductor, and/or a battery). An electrical energy source may also include a battery cell, or a plurality of battery cells connected in series into a module and each module connected in series or in parallel with other modules. Configuration of an energy source containing connected modules may be designed to meet an energy or power requirement and may be designed to fit within a designated footprint in an electric aircraft in which aircraft 1000 may be incorporated.

In an embodiment, and still referring to FIG. 10, an energy source may be used to provide a steady supply of electrical power to a load over the course of a flight by a vehicle or other electric aircraft. For example, an energy source may be capable of providing sufficient power for “cruising” and other relatively low-energy phases of flight. An energy source may also be capable of providing electrical power for some higher-power phases of flight as well, particularly when the energy source is at a high SOC, as may be the case for instance during takeoff. In an embodiment, an energy source may be capable of providing sufficient electrical power for auxiliary loads including without limitation, lighting, navigation, communications, de-icing, steering or other systems requiring power or energy. Further, an energy source may be capable of providing sufficient power for controlled descent and landing protocols, including, without limitation, hovering descent or runway landing. As used herein an energy source may have high power density where electrical power an energy source can usefully produce per unit of volume and/or mass is relatively high. “Electrical power,” as used in this disclosure, is defined as a rate of electrical energy per unit time. An energy source may include a device for which power that may be produced per unit of volume and/or mass has been optimized, at the expense of the maximal total specific energy density or power capacity, during design. Non-limiting examples of items that may be used as at least an energy source may include batteries used for starting applications including Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode, energy source may be used, in an embodiment, to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations, as described in further detail below. A battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. Persons skilled in the art, upon reviewing the entirety of this disclosure, will be aware of various devices of components that may be used as an energy source.

Still referring to FIG. 10, an energy source may include a plurality of energy sources, referred to herein as a module of energy sources. A module may include batteries connected in parallel or in series or a plurality of modules connected either in series or in parallel designed to deliver both the power and energy requirements of the application. Connecting batteries in series may increase the voltage of at least an energy source which may provide more power on demand. High voltage batteries may require cell matching when high peak load is needed. As more cells are connected in strings, there may exist the possibility of one cell failing which may increase resistance in the module and reduce an overall power output as a voltage of the module may decrease as a result of that failing cell. Connecting batteries in parallel may increase total current capacity by decreasing total resistance, and it also may increase overall amp-hour capacity. Overall energy and power outputs of at least an energy source may be based on individual battery cell performance or an extrapolation based on measurement of at least an electrical parameter. In an embodiment where an energy source includes a plurality of battery cells, overall power output capacity may be dependent on electrical parameters of each individual cell. If one cell experiences high self-discharge during demand, power drawn from at least an energy source may be decreased to avoid damage to the weakest cell. An energy source may further include, without limitation, wiring, conduit, housing, cooling system and battery management system. Persons skilled in the art will be aware, after reviewing the entirety of this disclosure, of many different components of an energy source.

In an embodiment and still referring to FIG. 10, plurality of flight components 1008 may be arranged in a quad copter orientation. As used in this disclosure a “quad copter orientation” is at least a lift propulsor component oriented in a geometric shape and/or pattern, wherein each of the lift propulsor components are located along a vertex of the geometric shape. For example, and without limitation, a square quad copter orientation may have four lift propulsor components oriented in the geometric shape of a square, wherein each of the four lift propulsor components are located along the four vertices of the square shape. As a further non-limiting example, a hexagonal quad copter orientation may have six lift propulsor components oriented in the geometric shape of a hexagon, wherein each of the six lift propulsor components are located along the six vertices of the hexagon shape. In an embodiment, and without limitation, quad copter orientation may include a first set of lift propulsor components and a second set of lift propulsor components, wherein the first set of lift propulsor components and the second set of lift propulsor components may include two lift propulsor components each, wherein the first set of lift propulsor components and a second set of lift propulsor components are distinct from one another. For example, and without limitation, the first set of lift propulsor components may include two lift propulsor components that rotate in a clockwise direction, wherein the second set of lift propulsor components may include two lift propulsor components that rotate in a counterclockwise direction. In an embodiment, and without limitation, the first set of propulsor lift components may be oriented along a line oriented 105° from the longitudinal axis of aircraft 1000. In another embodiment, and without limitation, the second set of propulsor lift components may be oriented along a line oriented 135° from the longitudinal axis, wherein the first set of lift propulsor components line and the second set of lift propulsor components are perpendicular to each other.

Still referring to FIG. 10, plurality of flight components 1008 may include a pusher component 1016. As used in this disclosure a “pusher component” is a component that pushes and/or thrusts an aircraft through a medium. As a non-limiting example, pusher component 1016 may include a pusher propeller, a paddle wheel, a pusher motor, a pusher propulsor, and the like. Additionally, or alternatively, pusher flight component may include a plurality of pusher flight components. Pusher component 1016 is configured to produce a forward thrust. As used in this disclosure a “forward thrust” is a thrust that forces aircraft through a medium in a horizontal direction, wherein a horizontal direction is a direction parallel to the longitudinal axis. As a non-limiting example, forward thrust may include a force of 1145 N to force aircraft to in a horizontal direction along the longitudinal axis. As a further non-limiting example, forward thrust may include a force of, as a non-limiting example, 300 N to force aircraft 1000 in a horizontal direction along a longitudinal axis. As a further non-limiting example, pusher component 1016 may twist and/or rotate to pull air behind it and, at the same time, push aircraft 1000 forward with an equal amount of force. In an embodiment, and without limitation, the more air forced behind aircraft, the greater the thrust force with which the aircraft is pushed horizontally will be. In another embodiment, and without limitation, forward thrust may force aircraft 1000 through the medium of relative air. Additionally or alternatively, plurality of flight components 1008 may include one or more puller components. As used in this disclosure a “puller component” is a component that pulls and/or tows an aircraft through a medium. As a non-limiting example, puller component may include a flight component such as a puller propeller, a puller motor, a tractor propeller, a puller propulsor, and the like. Additionally, or alternatively, puller component may include a plurality of puller flight components.

In an embodiment and still referring to FIG. 10, aircraft 1000 may include a flight controller located within fuselage 1004, wherein a flight controller is described in detail below, in reference to FIG. 10. In an embodiment, and without limitation, flight controller may be configured to operate a fixed-wing flight capability. As used in this disclosure a “fixed-wing flight capability” is a method of flight wherein the plurality of laterally extending elements generate lift. For example, and without limitation, fixed-wing flight capability may generate lift as a function of an airspeed of aircraft 100 and one or more airfoil shapes of the laterally extending elements, wherein an airfoil is described above in detail. As a further non-limiting example, flight controller may operate the fixed-wing flight capability as a function of reducing applied torque on lift propulsor component 1012. For example, and without limitation, flight controller may reduce a torque of 19 Nm applied to a first set of lift propulsor components to a torque of 16 Nm. As a further non-limiting example, flight controller may reduce a torque of 12 Nm applied to a first set of lift propulsor components to a torque of 0 Nm. In an embodiment, and without limitation, flight controller may produce fixed-wing flight capability as a function of increasing forward thrust exerted by pusher component 1016. For example, and without limitation, flight controller may increase a forward thrust of 1000 kN produced by pusher component 1016 to a forward thrust of 1669 kN. In an embodiment, and without limitation, an amount of lift generation may be related to an amount of forward thrust generated to increase airspeed velocity, wherein the amount of lift generation may be directly proportional to the amount of forward thrust produced. Additionally or alternatively, flight controller may include an inertia compensator. As used in this disclosure an “inertia compensator” is one or more computing devices, electrical components, logic circuits, processors, and the like there of that are configured to compensate for inertia in one or more lift propulsor components present in aircraft 1000. Inertia compensator may alternatively or additionally include any computing device used as an inertia compensator as described in U.S. Nonprovisional application Ser. No. 17/106,557, and entitled “SYSTEM AND METHOD FOR FLIGHT CONTROL IN ELECTRIC AIRCRAFT,” the entirety of which is incorporated herein by reference.

In an embodiment, and still referring to FIG. 10, flight controller may be configured to perform a reverse thrust command. As used in this disclosure a “reverse thrust command” is a command to perform a thrust that forces a medium towards the relative air opposing aircraft 190. For example, reverse thrust command may include a thrust of 180 N directed towards the nose of aircraft to at least repel and/or oppose the relative air. Reverse thrust command may alternatively or additionally include any reverse thrust command as described in U.S. Nonprovisional application Ser. No. 17/319,155 and entitled “AIRCRAFT HAVING REVERSE THRUST CAPABILITIES,” the entirety of which is incorporated herein by reference. In another embodiment, flight controller may be configured to perform a regenerative drag operation. As used in this disclosure a “regenerative drag operation” is an operating condition of an aircraft, wherein the aircraft has a negative thrust and/or is reducing in airspeed velocity. For example, and without limitation, regenerative drag operation may include a positive propeller speed and a negative propeller thrust. Regenerative drag operation may alternatively or additionally include any regenerative drag operation as described in U.S. Nonprovisional application Ser. No. 17/319,155.

In an embodiment, and still referring to FIG. 10, flight controller may be configured to perform a corrective action as a function of a failure event. As used in this disclosure a “corrective action” is an action conducted by the plurality of flight components to correct and/or alter a movement of an aircraft. For example, and without limitation, a corrective action may include an action to reduce a yaw torque generated by a failure event. Additionally or alternatively, corrective action may include any corrective action as described in U.S. Nonprovisional application Ser. No. 17/222,539, and entitled “AIRCRAFT FOR SELF-NEUTRALIZING FLIGHT,” the entirety of which is incorporated herein by reference. As used in this disclosure a “failure event” is a failure of a lift propulsor component of the plurality of lift propulsor components. For example, and without limitation, a failure event may denote a rotation degradation of a rotor, a reduced torque of a rotor, and the like thereof.

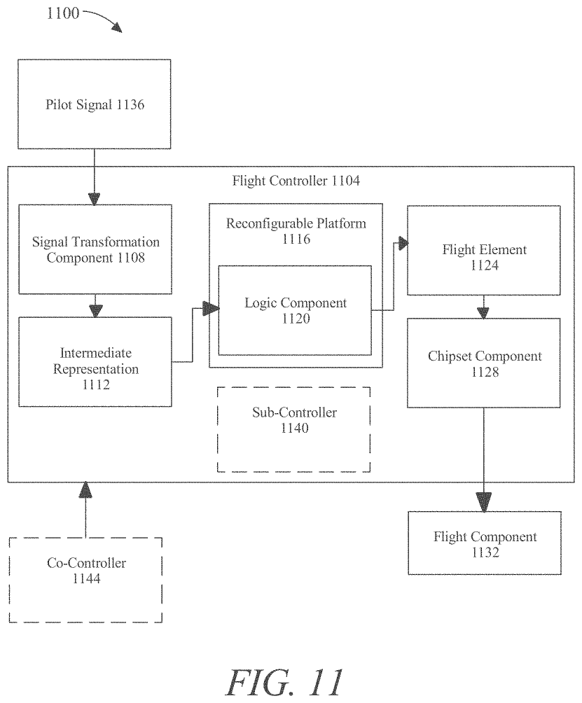

Now referring to FIG. 11, an exemplary embodiment 1100 of a flight controller 1104 is illustrated. As used in this disclosure a “flight controller” is a computing device of a plurality of computing devices dedicated to data storage, security, distribution of traffic for load balancing, and flight instruction. Flight controller 1104 may include and/or communicate with any computing device as described in this disclosure, including without limitation a microcontroller, microprocessor, digital signal processor (DSP) and/or system on a chip (SoC) as described in this disclosure. Further, flight controller 1104 may include a single computing device operating independently, or may include two or more computing device operating in concert, in parallel, sequentially or the like; two or more computing devices may be included together in a single computing device or in two or more computing devices. In embodiments, flight controller 1104 may be installed in an aircraft, may control the aircraft remotely, and/or may include an element installed in the aircraft and a remote element in communication therewith.

In an embodiment, and still referring to FIG. 11, flight controller 1104 may include a signal transformation component 1108. As used in this disclosure a “signal transformation component” is a component that transforms and/or converts a first signal to a second signal, wherein a signal may include one or more digital and/or analog signals. For example, and without limitation, signal transformation component 1108 may be configured to perform one or more operations such as preprocessing, lexical analysis, parsing, semantic analysis, and the like thereof. In an embodiment, and without limitation, signal transformation component 1108 may include one or more analog-to-digital convertors that transform a first signal of an analog signal to a second signal of a digital signal. For example, and without limitation, an analog-to-digital converter may convert an analog input signal to a 11-bit binary digital representation of that signal. In another embodiment, signal transformation component 1108 may include transforming one or more low-level languages such as, but not limited to, machine languages and/or assembly languages. For example, and without limitation, signal transformation component 1108 may include transforming a binary language signal to an assembly language signal. In an embodiment, and without limitation, signal transformation component 1108 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 11, signal transformation component 1108 may be configured to optimize an intermediate representation 1112. As used in this disclosure an “intermediate representation” is a data structure and/or code that represents the input signal. Signal transformation component 1108 may optimize intermediate representation as a function of a data-flow analysis, dependence analysis, alias analysis, pointer analysis, escape analysis, and the like thereof. In an embodiment, and without limitation, signal transformation component 1108 may optimize intermediate representation 1112 as a function of one or more inline expansions, dead code eliminations, constant propagation, loop transformations, and/or automatic parallelization functions. In another embodiment, signal transformation component 1108 may optimize intermediate representation as a function of a machine dependent optimization such as a peephole optimization, wherein a peephole optimization may rewrite short sequences of code into more efficient sequences of code. Signal transformation component 1108 may optimize intermediate representation to generate an output language, wherein an “output language,” as used herein, is the native machine language of flight controller 1104. For example, and without limitation, native machine language may include one or more binary and/or numerical languages.

In an embodiment, and without limitation, signal transformation component 1108 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 11, flight controller 1104 may include a reconfigurable hardware platform 1116. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 1116 may be reconfigured to enact any algorithm and/or algorithm selection process received from another computing device and/or created using machine-learning processes.

Still referring to FIG. 11, reconfigurable hardware platform 1116 may include a logic component 1120. As used in this disclosure a “logic component” is a component that executes instructions on output language. For example, and without limitation, logic component may perform basic arithmetic, logic, controlling, input/output operations, and the like thereof. Logic component 1120 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 1120 may be organized according to Von Neumann and/or Harvard architecture as a non-limiting example. Logic component 1120 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 1120 may include one or more integrated circuit microprocessors, which may contain one or more central processing units, central processors, and/or main processors, on a single metal-oxide-semiconductor chip. Logic component 1120 may be configured to execute a sequence of stored instructions to be performed on the output language and/or intermediate representation 1112. Logic component 1120 may be configured to fetch and/or retrieve the instruction from a memory cache, wherein a “memory cache,” as used in this disclosure, is a stored instruction set on flight controller 1104. Logic component 1120 may be configured to decode the instruction retrieved from the memory cache to opcodes and/or operands. Logic component 1120 may be configured to execute the instruction on intermediate representation 1112 and/or output language. For example, and without limitation, logic component 1120 may be configured to execute an addition operation on intermediate representation 1112 and/or output language.

In an embodiment, and without limitation, logic component 1120 may be configured to calculate a flight element 1124. As used in this disclosure a “flight element” is an element of datum denoting a relative status of aircraft. For example, and without limitation, flight element 1124 may denote one or more torques, thrusts, airspeed velocities, forces, altitudes, groundspeed velocities, directions during flight, directions facing, forces, orientations, and the like thereof. For example, and without limitation, flight element 1124 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 1124 may denote that aircraft is following a flight path accurately and/or sufficiently.

Still referring to FIG. 11, flight controller 1104 may include a chipset component 1128. As used in this disclosure a “chipset component” is a component that manages data flow. In an embodiment, and without limitation, chipset component 1128 may include a northbridge data flow path, wherein the northbridge dataflow path may manage data flow from logic component 1120 to a high-speed device and/or component, such as a RAM, graphics controller, and the like thereof. In another embodiment, and without limitation, chipset component 1128 may include a southbridge data flow path, wherein the southbridge dataflow path may manage data flow from logic component 1120 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 1128 may manage data flow between logic component 1120, memory cache, and a flight component 1132. As used in this disclosure a “flight component” is a portion of an aircraft that can be moved or adjusted to affect one or more flight elements. For example, flight component 1132 may include a component used to affect the aircrafts' roll and pitch which may comprise one or more ailerons. As a further example, flight component 1132 may include a rudder to control yaw of an aircraft. In an embodiment, chipset component 1128 may be configured to communicate with a plurality of flight components as a function of flight element 1124. For example, and without limitation, chipset component 1128 may transmit to an aircraft rotor to reduce torque of a first lift propulsor and increase the forward thrust produced by a pusher component to perform a flight maneuver.

In an embodiment, and still referring to FIG. 11, flight controller 1104 may be configured generate an autonomous function. As used in this disclosure an “autonomous function” is a mode and/or function of flight controller 1104 that controls aircraft automatically. For example, and without limitation, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 1124. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 1104 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 1104 will control the ailerons and/or rudders. As used in this disclosure “non-autonomous mode” is a mode that denotes a pilot will control aircraft and/or maneuvers of aircraft in its entirety.

In an embodiment, and still referring to FIG. 11, flight controller 1104 may generate autonomous function as a function of an autonomous machine-learning model. As used in this disclosure an “autonomous machine-learning model” is a machine-learning model to produce an autonomous function output given flight element 1124 and a pilot signal 1136 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 1136 may denote that a pilot is controlling and/or maneuvering ailerons, wherein the pilot is not in control of the rudders and/or propulsors. In an embodiment, pilot signal 1136 may include an implicit signal and/or an explicit signal. For example, and without limitation, pilot signal 1136 may include an explicit signal, wherein the pilot explicitly states there is a lack of control and/or desire for autonomous function. As a further non-limiting example, pilot signal 1136 may include an explicit signal directing flight controller 1104 to control and/or maintain a portion of aircraft, a portion of the flight plan, the entire aircraft, and/or the entire flight plan. As a further non-limiting example, pilot signal 1136 may include an implicit signal, wherein flight controller 1104 detects a lack of control such as by a malfunction, torque alteration, flight path deviation, and the like thereof. In an embodiment, and without limitation, pilot signal 1136 may include one or more explicit signals to reduce torque, and/or one or more implicit signals that torque may be reduced due to reduction of airspeed velocity. In an embodiment, and without limitation, pilot signal 1136 may include one or more local and/or global signals. For example, and without limitation, pilot signal 1136 may include a local signal that is transmitted by a pilot and/or crew member. As a further non-limiting example, pilot signal 1136 may include a global signal that is transmitted by air traffic control and/or one or more remote users that are in communication with the pilot of aircraft. In an embodiment, pilot signal 1136 may be received as a function of a tri-state bus and/or multiplexor that denotes an explicit pilot signal should be transmitted prior to any implicit or global pilot signal.

Still referring to FIG. 11, autonomous machine-learning model may include one or more autonomous machine-learning processes such as supervised, unsupervised, or reinforcement machine-learning processes that flight controller 1104 and/or a remote device may or may not use in the generation of autonomous function. As used in this disclosure “remote device” is an external device to flight controller 1104. Additionally or alternatively, autonomous machine-learning model may include one or more autonomous machine-learning processes that a field-programmable gate array (FPGA) may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 11, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Flight controller 1104 may receive autonomous training data by receiving correlations of flight element, pilot signal, and/or simulation data to an autonomous function that were previously received and/or determined during a previous iteration of generation of autonomous function. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 11, flight controller 1104 may receive autonomous machine-learning model from a remote device and/or FPGA that utilizes one or more autonomous machine learning processes, wherein a remote device and an FPGA is described above in detail. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 1104. Remote device and/or FPGA may transmit a signal, bit, datum, or parameter to flight controller 1104 that at least relates to autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 1104 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 11, flight controller 1104 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 11, flight controller 1104 may include, but is not limited to, for example, a cluster of flight controllers in a first location and a second flight controller or cluster of flight controllers in a second location. Flight controller 1104 may include one or more flight controllers dedicated to data storage, security, distribution of traffic for load balancing, and the like. Flight controller 1104 may be configured to distribute one or more computing tasks as described below across a plurality of flight controllers, which may operate in parallel, in series, redundantly, or in any other manner used for distribution of tasks or memory between computing devices. For example, and without limitation, flight controller 1104 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Mass., USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 11, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 1132. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 11, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 1104. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 1112 and/or output language from logic component 1120, wherein output language may include one or more analog-to-digital conversions, low bit rate transmissions, message encryptions, digital signals, binary signals, logic signals, analog signals, and the like thereof described above in detail.

Still referring to FIG. 11, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 11, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 11, flight controller 1104 may also be implemented using a “shared nothing” architecture in which data is cached at the worker, in an embodiment, this may enable scalability of aircraft and/or computing device. Flight controller 1104 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 11, a node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. In an embodiment, and without limitation, a neural network may receive semantic units as inputs and output vectors representing such semantic units according to weights wᵢ that are derived using machine-learning processes as described in this disclosure.

Still referring to FIG. 11, flight controller may include a sub-controller 1140. As used in this disclosure a “sub-controller” is a controller and/or component that is part of a distributed controller as described above; for instance, flight controller 1104 may be and/or include a distributed flight controller made up of one or more sub-controllers. For example, and without limitation, sub-controller 1140 may include any controllers and/or components thereof that are similar to distributed flight controller and/or flight controller as described above. Sub-controller 1140 may include any component of any flight controller as described above. Sub-controller 1140 may be implemented in any manner suitable for implementation of a flight controller as described above. As a further non-limiting example, sub-controller 1140 may include one or more processors, logic components and/or computing devices capable of receiving, processing, and/or transmitting data across the distributed flight controller as described above. As a further non-limiting example, sub-controller 1140 may include a controller that receives a signal from a first flight controller and/or first distributed flight controller component and transmits the signal to a plurality of additional sub-controllers and/or flight components.

Still referring to FIG. 11, flight controller may include a co-controller 1144. As used in this disclosure a “co-controller” is a controller and/or component that joins flight controller 1104 as components and/or nodes of a distributer flight controller as described above. For example, and without limitation, co-controller 1144 may include one or more controllers and/or components that are similar to flight controller 1104. As a further non-limiting example, co-controller 1144 may include any controller and/or component that joins flight controller 1104 to distributer flight controller. As a further non-limiting example, co-controller 1144 may include one or more processors, logic components and/or computing devices capable of receiving, processing, and/or transmitting data to and/or from flight controller 1104 to distributed flight control system. Co-controller 1144 may include any component of any flight controller as described above. Co-controller 1144 may be implemented in any manner suitable for implementation of a flight controller as described above. In an embodiment, and with continued reference to FIG. 11, flight controller 1104 may be designed and/or configured to perform any method, method step, or sequence of method steps in any embodiment described in this disclosure, in any order and with any degree of repetition. For instance, flight controller 1104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing

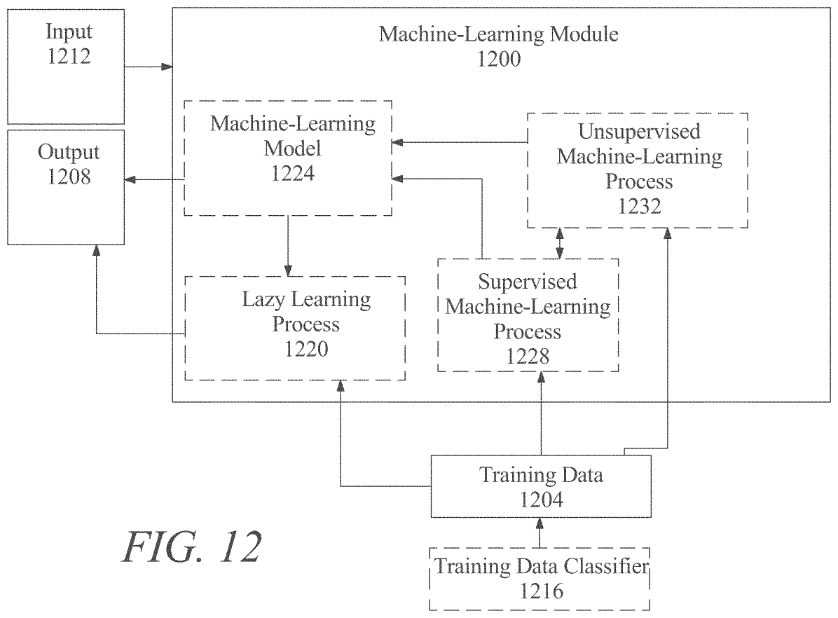

Referring now to FIG. 12, an exemplary embodiment of a machine-learning module 1200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1204 to generate an algorithm that will be performed by a computing device/module to produce outputs 1208 given data provided as inputs 1212; this is in contrast to a non-machine learning software program where the commands to be executed are determined in advance by a user and written in a programming language.

Still referring to FIG. 12, “training data,” as used herein, is data containing correlations that a machine-learning process may use to model relationships between two or more categories of data elements. For instance, and without limitation, training data 1204 may include a plurality of data entries, each entry representing a set of data elements that were recorded, received, and/or generated together; data elements may be correlated by shared existence in a given data entry, by proximity in a given data entry, or the like. Multiple data entries in training data 1204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1204 according to various correlations; correlations may indicate causative and/or predictive links between categories of data elements, which may be modeled as relationships such as mathematical relationships by machine-learning processes as described in further detail below. Training data 1204 may be formatted and/or organized by categories of data elements, for instance by associating data elements with one or more descriptors corresponding to categories of data elements. As a non-limiting example, training data 1204 may include data entered in standardized forms by persons or processes, such that entry of a given data element in a given field in a form may be mapped to one or more descriptors of categories. Elements in training data 1204 may be linked to descriptors of categories by tags, tokens, or other data elements; for instance, and without limitation, training data 1204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 12, training data 1204 may include one or more elements that are not categorized; that is, training data 1204 may not be formatted or contain descriptors for some elements of data. Machine-learning algorithms and/or other processes may sort training data 1204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1204 to be made applicable for two or more distinct machine-learning algorithms as described in further detail below. Training data 1204 used by machine-learning module 1200 may correlate any input data as described in this disclosure to any output data as described in this disclosure. As a non-limiting illustrative example inputs may include the input datum and outputs may include the simulation datum and altitude command datum.

Further referring to FIG. 12, training data may be filtered, sorted, and/or selected using one or more supervised and/or unsupervised machine-learning processes and/or models as described in further detail below; such models may include without limitation a training data classifier 1216. Training data classifier 1216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 1200 may generate a classifier using a classification algorithm, defined as a processes whereby a computing device and/or any module and/or component operating thereon derives a classifier from training data 1204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1216 may classify elements of training data to various training sessions based on a vehicle performance model output for which a subset of training data may be selected].

Still referring to FIG. 12, machine-learning module 1200 may be configured to perform a lazy-learning process 1220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1204. Heuristic may include selecting some number of highest-ranking associations and/or training data 1204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 12, machine-learning processes as described in this disclosure may be used to generate machine-learning models 1224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 1224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1224 may be generated by creating an artificial neural network, such as a convolutional neural network comprising an input layer of nodes, one or more intermediate layers, and an output layer of nodes. Connections between nodes may be created via the process of “training” the network, in which elements from a training data 1204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 12, machine-learning algorithms may include at least a supervised machine-learning process 1228. At least a supervised machine-learning process 1228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs such as any datum received from a database and a vehicle performance model output, a training data correlating the datum from any database to a model, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1204. Persons skilled in the art, upon reviewing the entirety of this disclosure, will be aware of various possible variations of at least a supervised machine-learning process 1228 that may be used to determine relation between inputs and outputs. Supervised machine-learning processes may include classification algorithms as defined above.

Further referring to FIG. 12, machine learning processes may include at least an unsupervised machine-learning processes 1232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 12, machine-learning module 1200 may be designed and configured to create a machine-learning model 1224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 12, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

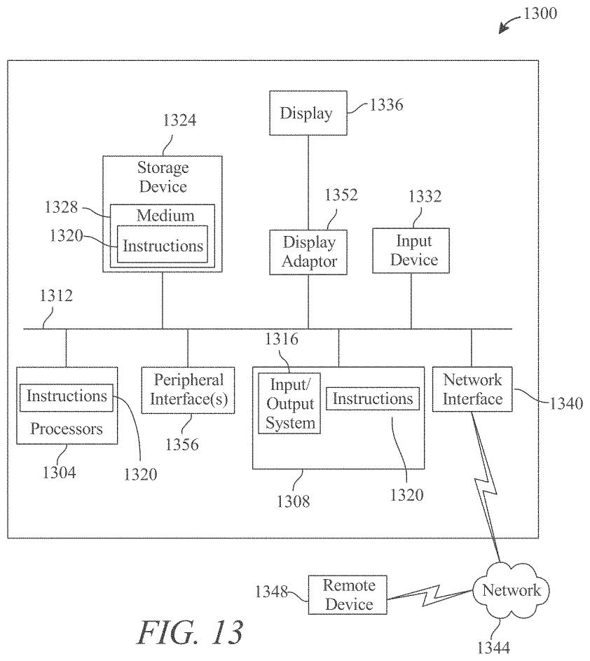

FIG. 13 shows a diagrammatic representation of one embodiment of a computing device in the exemplary form of a computer system 1300 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1300 includes a processor 1304 and a memory 1308 that communicate with each other, and with other components, via a bus 1312. Bus 1312 may include any of several types of bus structures including, but not limited to, a memory bus, a memory controller, a peripheral bus, a local bus, and any combinations thereof, using any of a variety of bus architectures.

Processor 1304 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1304 may be organized according to Von Neumann and/or Harvard architecture as a non-limiting example. Processor 1304 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1308 may include various components (e.g., machine-readable media) including, but not limited to, a random-access memory component, a read only component, and any combinations thereof. In one example, a basic input/output system 1316 (BIOS), including basic routines that help to transfer information between elements within computer system 1300, such as during start-up, may be stored in memory 1308. Memory 1308 may also include (e.g., stored on one or more machine-readable media) instructions (e.g., software) 1320 embodying any one or more of the aspects and/or methodologies of the present disclosure. In another example, memory 1308 may further include any number of program modules including, but not limited to, an operating system, one or more application programs, other program modules, program data, and any combinations thereof.

Computer system 1300 may also include a storage device 1324. Examples of a storage device (e.g., storage device 1324) include, but are not limited to, a hard disk drive, a magnetic disk drive, an optical disc drive in combination with an optical medium, a solid-state memory device, and any combinations thereof. Storage device 1324 may be connected to bus 1312 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1324 (or one or more components thereof) may be removably interfaced with computer system 1300 (e.g., via an external port connector (not shown)). Particularly, storage device 1324 and an associated machine-readable medium 1328 may provide nonvolatile and/or volatile storage of machine-readable instructions, data structures, program modules, and/or other data for computer system 1300. In one example, software 1320 may reside, completely or partially, within machine-readable medium 1328. In another example, software 1320 may reside, completely or partially, within processor 1304.

Computer system 1300 may also include an input device 1332. In one example, a user of computer system 1300 may enter commands and/or other information into computer system 1300 via input device 1332. Examples of an input device 1332 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1332 may be interfaced to bus 1312 via any of a variety of interfaces (not shown) including, but not limited to, a serial interface, a parallel interface, a game port, a USB interface, a FIREWIRE interface, a direct interface to bus 1312, and any combinations thereof. Input device 1332 may include a touch screen interface that may be a part of or separate from display 1336, discussed further below. Input device 1332 may be utilized as a user selection device for selecting one or more graphical representations in a graphical interface as described above.

A user may also input commands and/or other information to computer system 1300 via storage device 1324 (e.g., a removable disk drive, a flash drive, etc.) and/or network interface device 1340. A network interface device, such as network interface device 1340, may be utilized for connecting computer system 1300 to one or more of a variety of networks, such as network 1344, and one or more remote devices 1348 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1344, may employ a wired and/or a wireless mode of communication. In general, any network topology may be used. Information (e.g., data, software 1320, etc.) may be communicated to and/or from computer system 1300 via network interface device 1340.

Computer system 1300 may further include a video display adapter 1352 for communicating a displayable image to a display device, such as display device 1336. Examples of a display device include, but are not limited to, a liquid crystal display (LCD), a cathode ray tube (CRT), a plasma display, a light emitting diode (LED) display, and any combinations thereof. Display adapter 1352 and display device 1336 may be utilized in combination with processor 1304 to provide graphical representations of aspects of the present disclosure. In addition to a display device, computer system 1300 may include one or more other peripheral output devices including, but not limited to, an audio speaker, a printer, and any combinations thereof. Such peripheral output devices may be connected to bus 1312 via a peripheral interface 1356. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system for instantaneous communication between simulators, the system comprising:
a plurality of simulation devices comprising a first simulation device and a second simulation device which are located in remote and isolated positions from each other, each of the plurality of simulation devices comprising:
a first computing device comprising a processor, wherein the first computing device:
generates a machine-learning model, wherein the machine-learning model is configured to receive an input datum;
simulates a vehicle performance model output as a function of the input data and the machine-learning model;
generates a simulation datum as a function of the performance model output; and
transmits the simulation datum to the database;
a mesh network, the mesh network configured to communicatively connect the plurality of simulation devices, wherein the system is further configured to support the operation of a plurality of vehicle simulations each operated by at least one of a plurality of users on a respective simulation device of the plurality of simulation devices as a function of the plurality of simulation devices communicatively connected by the mesh network;
a communication device configured to receive the simulation datum, wherein the communications device is a second computing device, the communication device comprising:
an authentication module operating on the communication device, wherein the authentication module comprises executable software that is configured to authenticate a credential associated with the first simulation device to allow access of the first simulation device to the second simulation device, wherein the executable software is executed by the processor of the second computing device;
an automated broadcaster configured to transmit the simulation datum to at least a simulation device from the plurality of simulation devices; and
a plurality of communication components, each communication component of the plurality of communication components configured to facilitate instantaneous communication between the plurality of simulation devices; and
at least a database, the at least a database configured to store the simulation datum.

2. The system of claim 1, wherein the simulation of the vehicle performance model output comprises a simulation of an electric aircraft.

3. (canceled)

4. The system of claim 1, wherein the authentication module further comprises executable software that is configured to:
compare the credential to an authorized credential stored within an authentication database; and
allow the first simulation device to access the second simulation device if the credential and the authorized credential match.

5. The system of claim 1, wherein each of the plurality of communication components further comprises a transceiver.

6. The system of claim 1, wherein each simulation device of the plurality of simulation devices are located in different locations from each other.

7. The system of claim 1, wherein the first simulation device of the plurality of simulation devices, operated by a first user is configured to:
take control over the second simulation device of the plurality of simulation devices; and
display real-time movements of the simulated vehicle performance model output of the second simulation device operated by a second user.

8. The system of claim 1, wherein:
the first simulation device is configured to:
receive a second input datum;
generate an altitude command datum as a function of the second input datum; and
transmit the altitude command datum to the second simulation device;
the second simulation device is configured to:
receive the altitude command datum from the first simulation device;
generate an altitude function as a function of the altitude command datum; and
perform a torque allocation as a function of the altitude function.

9. The system of claim 1, wherein the at least a database further comprises a cloud database, wherein the cloud database is configured to store the simulation data as a function of the communication device.

10. The system of claim 1, wherein the at least a database further comprises a local database, wherein the local database is configured to store the simulation datum as a function of the plurality of simulation devices.

11. A method for instantaneous communication between simulation devices, the method comprising:
receiving, by a first computing device of a simulation device of a plurality of simulation devices, an input datum, wherein the input datum is received by a machine-learning model, wherein the plurality of simulation devices comprises a first simulation device and a second simulation device which are located in remote and isolated positions from each other;
simulating a vehicle performance model output as a function of the input data and the machine-learning model;
generating a simulation datum as a function of the performance model output;
transmitting the simulation datum;
communicatively connecting the plurality of simulation devices as a function of a mesh network to support the operation of a plurality of vehicle simulations each operated by at least one of a plurality of users on a respective simulation device of the plurality of simulation devices as a function of the plurality of simulation devices communicatively connected by the mesh network;
receiving, by a communication device, wherein the communication device is a second computing device, the simulation datum;
authenticating, by an authentication module, a credential associated with the first simulation device to allow access of the first simulation device to the second simulation device;
facilitating, by each communication component of a plurality of communication components of the communication device, instantaneous communication between the plurality of simulation devices;
transmitting, by the communication device, the simulation datum to at least simulation device from the plurality of simulation devices as a function of an automated broadcaster; and
storing the simulation datum in at least a database.

12. The method of claim 11, wherein simulating the vehicle performance model output further comprises simulating an electric aircraft.

13. (canceled)

14. The method of claim 11, wherein authenticating the credential further comprises:
comparing the credential to an authorized credential stored within an authentication database; and
allowing the first simulation device to access the second simulation device if the credential and the authorized credential match.

15. The method of claim 11, wherein facilitating instantaneous communication by the plurality of communication components further comprises facilitating as a function of a transceiver.

16. The method of claim 11, wherein facilitating instantaneous further comprises facilitating as a function of each simulation device of the plurality of simulation devices in different locations from each other.

17. The method of claim 11, wherein facilitating instantaneous communication further comprises:
taking control over the second simulation device by the first simulation device; and
displaying real-time movements of the simulated vehicle performance model output of the second simulation device.

18. The method of claim 11, wherein facilitating instantaneous communication further comprises:
receiving, at the first simulation device, a second input datum;
generating an altitude command datum as a function of the second input datum;
transmitting the altitude command datum to the second simulation device;
receiving, at the second simulation device, the altitude command datum;
generating an altitude function as a function of the altitude command datum; and
performing a control allocation as a function of the altitude function.

19. The method of claim 11, wherein storing the simulation datum in at least a database further comprises storing the simulation data as a function of the communication device in a cloud database.

20. The method of claim 11, wherein storing the simulation datum in at least a database further comprises storing the simulation datum as a function of the simulation device in a local database.
